(19) United States
(12) Patent Application Publication
(10) Pub. No.: US 2026/0006239 A1
(43) Pub. Date: Jan. 1, 2026

(54) CHROMA MOTION VECTOR REFINEMENT USING RECONSTRUCTED LUMA OR CHROMA

(71) Applicant: Nokia Technologies Oy, Espoo (FI)

(72) Inventors: Limin WANG, San Diego, CA (US); Seungwook HONG, San Diego, CA (US); Krit PANUSOPONE, San Diego, CA (US)

(21) Appl. No.: 19/227,130

(22) Filed: Jun. 3, 2025

Related U.S. Application Data
(60) Provisional application No. 63/665,627, filed on Jun. 28, 2024.

(51) Int. Cl. H04N 19/52; H04N 19/186

(52) U.S. Cl. CPC H04N 19/52; H04N 19/186

(57) ABSTRACT

In an inter-frame prediction process for frames of video, a luma block is selected to be coded first for a current coding unit to form a reconstructed luma block of the current coding unit. MV(s) are refined that point from the luma block to a prediction luma block in a reference picture of the video. One of the refined MV(s) is selected to code chroma blocks for the current coding unit. In an inter-frame prediction process for frames of video, chroma blocks are selected to be coded first for a current coding unit to form reconstructed chroma blocks of the current coding unit. MV(s) are refined that point from the reconstructed chroma blocks to prediction chroma blocks in a reference picture of the video. One of the refined MV(s) is selected to code a luma block for the current coding unit.

### TECHNICAL FIELD

Examples of embodiments herein relate generally to encoding and decoding of video and, more specifically, relate to motion vectors and their use in encoding and decoding of video.

### BACKGROUND

In video compression, motion vectors (MVs) are a crucial component of many popular codecs (coder/decoders), including VVC (Versatile Video Coding) and ECM (Enhanced Compression Model). Motion vectors are 2D vectors that represent the movement of objects within a video frame from one frame to another. The MVs are used to encode the motion information between two consecutive frames, which is then used by the decoder to predict the current frame based on the previous frame and the motion vector.

MVs may be determined using the following process. The video encoder (or decoder) calculates the difference between two adjacent frames (e.g., Frame A and Frame B). This difference is known as the “motion field”. The motion field is then analyzed to determine the movement of objects within each block of the frame. For each block, a vector is calculated that represents the displacement from Frame A to Frame B. This vector is the motion vector (MV). The motion vectors are then compressed using techniques like run-length encoding (RLE), differential pulse-code modulation (DPCM), or entropy coding (the latter used by VVC and ECM).

By encoding the motion information, motion vectors help reduce the amount of data required to encode a video sequence. For instance, motion vectors enable more efficient compression by representing the motion between frames using fewer bits than would be required to encode each frame separately. Furthermore, the decoder uses the motion vectors to predict the current frame based on the previous frame, which reduces the amount of data needed to transmit or store

Along with MVs, other motion-related techniques may be used. Consider Motion Vector Prediction (MVP), which is a technique used to predict the motion vector of a block in an upcoming frame. The goal is to reduce the number of motion vectors that need to be encoded and transmitted. To determine MVP, a set of reference frames is chosen from previous frames, typically 3-5 frames. For each block in the current frame, a motion vector is calculated by analyzing the differences between the current frame and each reference frame. The reference frame that best matches the current block is selected based on the minimum absolute difference between the two. Finally, the motion vector from the best-matching reference frame is used as the predicted motion vector for the current block. By predicting the motion vector, MVP reduces the number of unique motion vectors that need to be encoded and transmitted, which can lead to a more efficient compression ratio.

Another technique that may be used to further compress motion vectors is Motion Vector Difference (MVD). This technique is primarily used for luma blocks (e.g., grayscale information). For MVD, a reference motion vector is chosen from a previous frame or a previously decoded block. The difference between the actual motion vector of the current block and the reference motion vector is calculated. The difference (as the MVD) is then encoded using techniques like variable-length coding (VLC) or arithmetic coding. By encoding the difference instead of the entire motion vector, MVD can lead to a more efficient compression ratio for luma blocks.

In many video codecs, both Motion Vector Prediction (MVP) and Motion Vector Difference (MVD) are used together to achieve better compression ratios. MVP predicts the motion vector for each block, and then MVD encodes the difference between the predicted motion vector and the actual motion vector. This combination can lead to a more efficient compression ratio while maintaining good video quality.

While MVs, MVP, and MVD are helpful, improvements still can be achieved.

### BRIEF SUMMARY

This section is intended to include examples and is not intended to be limiting.

In an exemplary embodiment, a method is disclosed that includes in an inter-frame prediction process for frames of video, selecting a luma block to be coded first for a current coding unit to form a reconstructed luma block of the current coding unit; refining one or more motion vectors that point from the luma block to a prediction luma block in a reference picture of the video; and selecting one of the refined one or more motion vectors to code chroma blocks for the current coding unit.

An additional exemplary embodiment includes a computer program, comprising instructions for performing the method of the previous paragraph, when the computer program is run on an apparatus. The computer program according to this paragraph, wherein the computer program is a computer program product comprising a computer-readable medium bearing the instructions embodied therein for use with the apparatus. Another example is the computer program according to this paragraph, wherein the program is directly loadable into an internal memory of the apparatus.

An exemplary apparatus includes one or more processors and one or more memories storing instructions that, when executed by the one or more processors, cause the apparatus at least to perform: in an inter-frame prediction process for frames of video, selecting a luma block to be coded first for a current coding unit to form a reconstructed luma block of the current coding unit; refining one or more motion vectors that point from the luma block to a prediction luma block in a reference picture of the video; and selecting one of the refined one or more motion vectors to code chroma blocks for the current coding unit.

An exemplary computer program product includes a computer-readable storage medium bearing instructions that, when executed by an apparatus, cause the apparatus to perform at least the following: in an inter-frame prediction process for frames of video, selecting a luma block to be coded first for a current coding unit to form a reconstructed luma block of the current coding unit; refining one or more motion vectors that point from the luma block to a prediction luma block in a reference picture of the video; and selecting one of the refined one or more motion vectors to code chroma blocks for the current coding unit.

In another exemplary embodiment, an apparatus comprises means for: in an inter-frame prediction process for frames of video, selecting a luma block to be coded first for a current coding unit to form a reconstructed luma block of the current coding unit; refining one or more motion vectors that point from the luma block to a prediction luma block in a reference picture of the video; and selecting one of the refined one or more motion vectors to code chroma blocks for the current coding unit.

In an exemplary embodiment, a method is disclosed that includes in an inter-frame prediction process for frames of video, selecting chroma blocks to be coded first for a current coding unit to form reconstructed chroma blocks of the current coding unit; refining one or more motion vectors that point from the reconstructed chroma blocks to prediction chroma blocks in a reference picture of the video; and selecting one of the refined one or more motion vectors to code a luma block for the current coding unit.

An additional exemplary embodiment includes a computer program, comprising instructions for performing the method of the previous paragraph, when the computer program is run on an apparatus. The computer program according to this paragraph, wherein the computer program is a computer program product comprising a computer-readable medium bearing the instructions embodied therein for use with the apparatus. Another example is the computer program according to this paragraph, wherein the program is directly loadable into an internal memory of the apparatus.

An exemplary apparatus includes one or more processors and one or more memories storing instructions that, when executed by the one or more processors, cause the apparatus at least to perform: in an inter-frame prediction process for frames of video, selecting chroma blocks to be coded first for a current coding unit to form reconstructed chroma blocks of the current coding unit; refining one or more motion vectors that point from the reconstructed chroma blocks to prediction chroma blocks in a reference picture of the video; and selecting one of the refined one or more motion vectors to code a luma block for the current coding unit.

An exemplary computer program product includes a computer-readable storage medium bearing instructions that, when executed by an apparatus, cause the apparatus to perform at least the following: in an inter-frame prediction process for frames of video, selecting chroma blocks to be coded first for a current coding unit to form reconstructed chroma blocks of the current coding unit; refining one or more motion vectors that point from the reconstructed chroma blocks to prediction chroma blocks in a reference picture of the video; and selecting one of the refined one or more motion vectors to code a luma block for the current coding unit.

In another exemplary embodiment, an apparatus comprises means for: in an inter-frame prediction process for frames of video, selecting chroma blocks to be coded first for a current coding unit to form reconstructed chroma blocks of the current coding unit; refining one or more motion vectors that point from the reconstructed chroma blocks to prediction chroma blocks in a reference picture of the video; and selecting one of the refined one or more motion vectors to code a luma block for the current coding unit.

### BRIEF DESCRIPTION OF THE DRAWINGS

The accompanying drawings use reference numerals, where the same reference numerals may be used to refer to like parts throughout, but parts having the same reference numeral can differ in operation and components. In the attached drawings:

FIG. 1 is a block diagram illustrating a system in accordance with an example;

FIG. 2 illustrates that template cost of a merge candidate is calculated based upon the difference between the templates of the merge candidate and the current CU;

FIG. 3 illustrates that the MV=MVP+MVD is refined within a small refinement area for chroma blocks;

FIG. 4 is a flowchart of a method for chroma motion vector refinement using reconstructed luma in one example;

FIG. 4A is a block diagram illustrating how to refine the MVs around MVP(1)+MVD(1) as well as around MVP (i), i=0, 2, 3, . . . , n−1;

FIG. 5 is a flowchart of a method for chroma motion vector refinement using reconstructed luma in one example;

FIG. 5A is a block diagram illustrating how the reconstructed luma block is compared with the prediction luma blocks associated with merge candidates MergeCand[i], i=0, 1, . . . , n−1;

FIG. 6 is a flowchart of a method for chroma motion vector refinement using reconstructed luma in one example;

FIG. 6A is a block diagram illustrating how the MVP(1) held in merge candidate MergeCand[1] is refined within a small refinement area for chroma blocks based on the reconstructed luma block;

FIG. 7 is a flowchart of a method for chroma motion vector refinement using reconstructed luma in one example;

FIG. 7A is a block diagram illustrating how the MVP(2) held in merge candidate MergeCand[2] is refined within a small refinement area for chroma blocks based on the reconstructed luma block;

FIG. 8 is a flowchart of a method for chroma motion vector refinement using reconstructed luma in one example;

FIG. 8A is a block diagram illustrating how the MVP(1) and MVP(2) held in merge candidate MergeCand[1] and merge candidate MergeCand[2] are refined within the small refinement areas for chroma blocks based on the reconstructed luma block;

FIG. 9 is a flowchart of a method for chroma motion vector refinement using reconstructed luma in one example;

FIG. 9A is a block diagram illustrating how the MVPs held in merge candidates are refined within small refinement areas for chroma blocks based on the reconstructed luma block;

FIG. 10 illustrates a VVC encoder where the encoder examples can be implemented;

FIG. 11 illustrates a VVC decoder where the decoder examples can be implemented;

FIG. 12 is an example of a block diagram of an apparatus suitable for implementing any of the encoders or decoders described herein;

FIG. 13 is a flowchart of a method for encoding a video using chroma motion vector refinement using reconstructed luma in accordance with an example; and

FIG. 14 is a flowchart of a method for decoding a video using chroma motion vector refinement using reconstructed luma in accordance with an example.

### DETAILED DESCRIPTION OF THE DRAWINGS

Abbreviations that may be found in the specification and/or the drawing figures are defined below, at the end of the detailed description section.

The word “exemplary” is used herein to mean “serving as an example, instance, or illustration.” Any embodiment described herein as “exemplary” is not necessarily to be construed as preferred or advantageous over other embodiments. All of the embodiments described in this Detailed Description are exemplary embodiments provided to enable persons skilled in the art to make or use the examples.

When more than one drawing reference numeral, word, or acronym is used within this description with “/”, and in general as used within this description, the “/” may be interpreted as “or”, “and”, or “both”. As used herein, “at least one of the following: <a list of two or more elements>” and “at least one of <a list of two or more elements>” and similar wording, where the list of two or more elements are joined by “and” or “or,” mean at least any one of the elements, or at least any two or more of the elements, or at least all the elements.

As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

It is noted that capital and lowercase words or phrases are considered to be the same herein. For instance, the words Slice and slice are the same, as are the phrases Network Repository Function and network repository function.

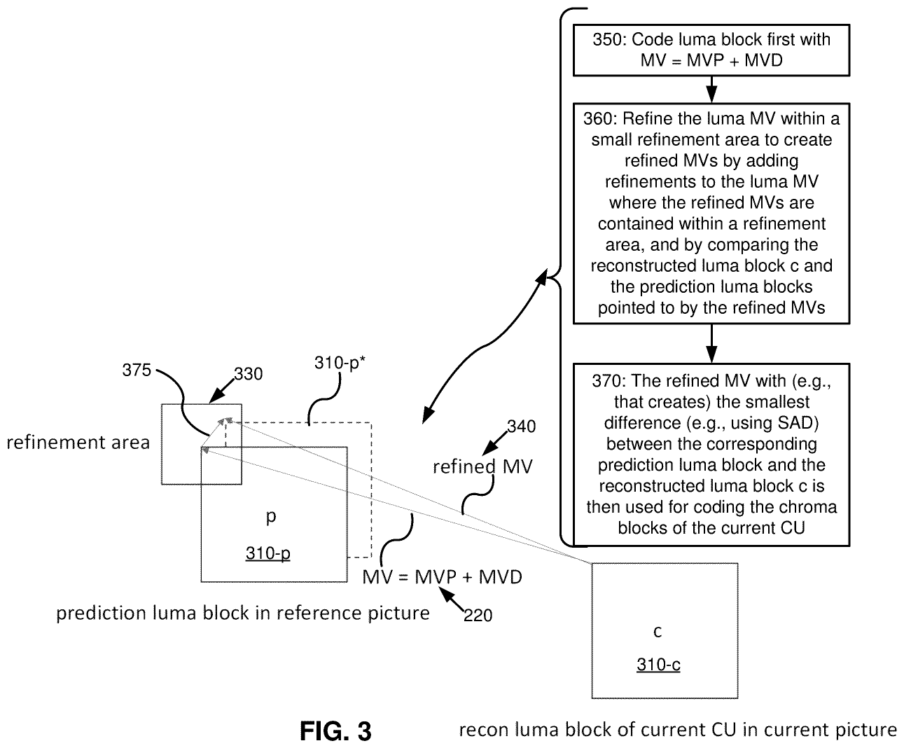

Any flow diagram (such as FIGS. 3, 4, 5, 6, 7, 8, or 9) herein is considered to be a logic flow diagram, and illustrates the operation of an exemplary method, results of execution of computer program instructions embodied on a computer readable memory, and/or functions performed by logic implemented in circuitry. For methods, flow diagrams, and signaling diagrams, the orders of method steps, blocks in the flow, or signaling are not critical and instead are examples.

Technical context is now provided for technical areas related to the understanding of the examples. One topic of interest is the color space. The instant document uses the example color space of YCbCr (luminance Y; blue chrominance Cb; red chrominance Cr). Luminance (Y) is a component that carries the brightness information (e.g., grayscale), which represents the intensity of the image. Chrominance (Cb and Cr) are responsible for carrying the color information of the image. In a digital video system, luminance is typically represented as an 8-bit or 10-bit value, with values ranging from 0 to 255 (8-bit) or 0 to 1023(10-bit). Higher values indicate greater brightness, while lower values indicate lesser brightness.

The chrominance components can be subsampled, as they are less relevant to the human visual system than is the luminance, and what is discarded creates minor or no perceptible visual degradation. The most common chrominance subsampling configurations (referred to below as video color formats) are 4:2:2 and 4:2:0. The 4:2:2 configuration includes two Cb and two Cr samples for four Y samples; whereas the 4:2:0 configuration includes one Ch and one Cr sample for four Y samples.

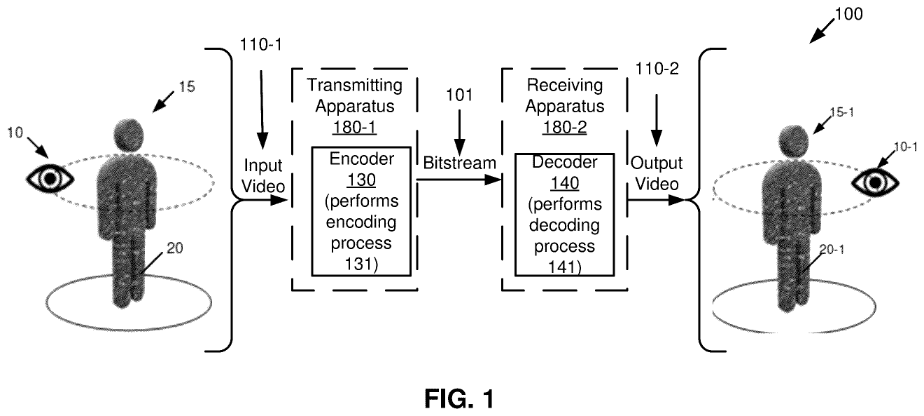

Another topic of interest includes a system that may be used herein. Referring to FIG. 1, this figure is a block diagram illustrating a system 100 in accordance with an example. In the example, the encoder 130 is used to encode input video 110-1 from the scene 15, and the encoder 130 is implemented in a transmitting apparatus 180-1. There is a capture of input video at a viewpoint 10 of a scene 15, which includes a human being 20. The encoder 130 produces a bitstream 101, using the encoding process 131 on the input video 110-1, that is received by the receiving apparatus 180-2. The receiving apparatus 180-2 implements a decoder 140, which performs a decoding process 141. The decoder 140, using the decoding process 141 on the bitstream 101, forms the output video 110-2 (as a representation of the input video 110-1) for the scene 15-1, and the receiving apparatus 180-2 would present this to the user, e.g., via a smartphone, television, or projector among many other options. The scene 15-1 has a viewpoint 10-1 and contains representations of at least a human being 20-1. The encoder 130 and decoder 140 may be applied to multiple coding standards.

One such standard is Versatile Video Coding (VVC), which is a new international video coding standard, and another such standard is Enhanced Compression Model (ECM), built on top of VVC, that is potentially a future video coding standard currently under development sponsored by JVET (Joint video experts team). Both VVC and ECM are block-based video coding standards, where an input picture is divided into Coding Tree Units (CTUs), and each CTU may be further split into Coding Units (CUs). A CU (one type of block) is coded in either inter-coding mode or intra-coding mode. If the block is in inter-coding mode, the encoder 130 searches for a temporal prediction block in reference picture(s) and signals the decoder 140 on how to find the same prediction block in reference picture(s) at the decoder end. If the block is in intra-coding mode, the encoder 130 constructs a spatial prediction block from the current picture and signals the decoder 140 on how to form the same spatial prediction block from the current picture at the decoder end.

For a current inter-CU in a current picture, the associated temporal prediction block in reference pictures is represented by motion information (e.g., motion vectors, reference pictures, reference lists) with respect to the current CU in the current picture. The encoder 130 signals the motion information to the decoder 140, and the decoder 140 uses the motion information to form the temporal prediction block from reference pictures.

In VVC and ECM, for a current CU, its motion information may include two parts: motion information prediction (e.g., motion vector prediction-MVP) and motion information delta (e.g., motion vector difference—MVD). For a current CU, its motion information prediction is derived from the motion information of the past inter-coded CUs in the current picture or in reference pictures, and on the other hand, the motion information delta is often coded in an explicit manner.

VVC and ECM support many new and refined coding tools for deriving the motion information prediction for a current CU. One of the coding tools is merge prediction, in which for a current CU, both encoder and decoder construct a same list of merge candidates. The merge candidates hold the motion information of the past inter-coded CUs around the current CU both spatially and temporally. Encoder 130 selects a merge candidate (e.g., motion information) from the merge candidate list for the current CU, and signals decoder 140 as to which merge candidate in the merge candidate list is to be used for the current CU.

In the current design of ECM, for a current CU in a current picture, the encoder and decoder may collect an initial set of merge candidates, including the following types of candidates:
Spatial merge candidates;
Temporal merge candidates;
Non-adjacent merge candidates;
History-based merge candidates;
History-based merge candidates from Affine HMVP (history-based motion vector prediction); and/or
Pairwise merge candidates.

The initial set of merge candidates may have up to 25 merge candidates. Each merge candidate holds the motion information (e.g., motion vectors, reference pictures, reference picture lists) of a post inter-coded CU. With the motion information of a merge candidate, the encoder and decoder are able to find the corresponding prediction block in a reference picture.

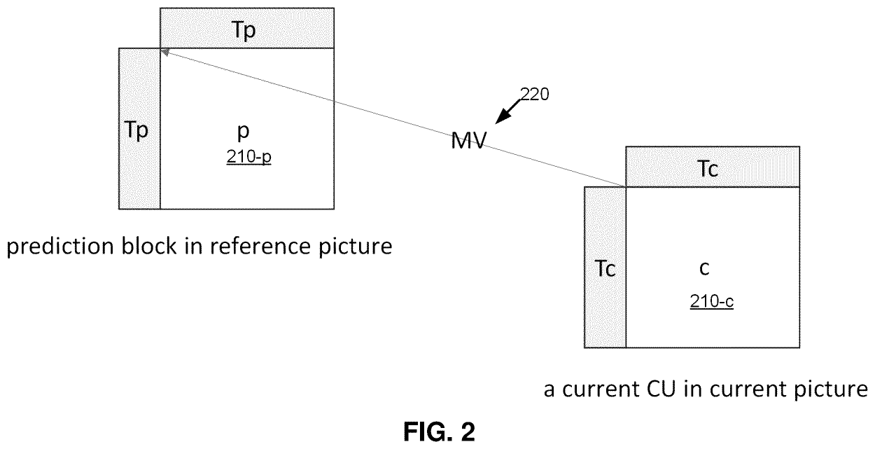

The left and above reconstructed neighboring pixels of the current CU and the prediction block form the template of the current CU (Tc) and the template of the corresponding prediction block (Tp), respectively, as shown in FIG. 2. The prediction block p (e.g., a CU) 210-p has two associated templates Tp, and the current block c (e.g., a CU) 210-c has two associated templates Tc. The motion vector MV 220 is illustrated from the upper left corner of the current CU 210-c to the upper left corner of the prediction block 210-p.

The template cost of a merge candidate against the current CU is defined as the difference (diff) between the template of the merge candidate (Tp) and the template (Tc) of the current CU, as per the following:

$$template cost = diff ( Tc - Tp ) .$$

One of possible metrics for this difference is SAD (sum of absolute difference).

In the current design of ECM, the encoder and decoder then sort the initial set of merge candidates based on their template costs, with the merge candidate having the lowest template cost appearing first in the sorted list. The sorting process is followed by a diversity process, which removes some merge candidates with similar motion information. The final merge candidate list contains up to 10 merge candidates in the current ECM design. Both encoder and decoder should have the same final merge candidate list.

The encoder 130 may code the current CU 210-c by using one of merge candidates in the merge candidate list. The motion information of the one of merge candidates is used for both luma and chroma components of the current CU. The encoder 130 needs to signal the decoder 140 as to which merge candidate is used to code the current CU 210-c.

Issues in this technical area include the following. In the current ECM design, for a current CU, the merge candidate list is constructed based upon the template costs of the initial merge candidates against the template of the current CU. The final merge candidate list may not necessarily be the best for the current CU. It is possible that some good initial merge candidates may not be included in the merge candidate list and the merge candidates in the final merge candidate list may not be ranked according to the differences between the current CU and the prediction blocks associated with the merge candidates in the merge candidate list.

To address these and other issues, examples herein propose that if a current CU is coded in inter mode, it may not be necessary for the luma and chroma components of the current CU to share the same motion vectors. An overview is provided now and further details are provided below. Note that in both VVC and ECM, for a current CU in inter-coding mode, the luma block and the chroma blocks share the same motion vectors, meaning the direction of their motion vectors are the same, but the actual lengths of their motion vectors may not be the same depending upon the video color formats (e.g., 4:2:0, 4:2:2, 4:4:4). For example, for 4:2:0 format, the chroma's motion vectors may be the scaled-down version of luma's motion vectors.

In the following, the “same” motion vector for luma block and chroma blocks mean the “same” motion vectors in direction before scaling. If the luma block of the current CU is coded first, the reconstructed luma block may be used to refine the motion vectors for the chroma blocks. If the chroma blocks of the current CU are coded first, the reconstructed chroma blocks may be used to refine the motion vectors for the luma.

Now that an overview has been provided, further details are provided. In the current ECM design, a motion vector (MV) for a current CU in inter-coding mode may include both motion vector predictor (MVP) and motion vector difference (MVD), or just MVP.

For a current CU, MVP is often derived from one of merge candidates in the merge candidate list. Both encoder and decoder should be able to derive the same MVP without signaling, but MVD is usually coded in an explicit way. In general, a current CU in inter-coding mode may be coded with MV=MVP+MVD (e.g., MMVD, AMVP, SMVD, BiMVD) or with MV=MVP (Merge Mode). Merge Mode is used when the estimated MV is close enough to the MVP (e.g., based on a metric), and the encoder can “merge” them by setting the MV equal to the MVP. This reduces the number of bits needed to represent the motion information. By using merge mode, the encoder can efficiently encode the motion information while maintaining a good balance between compression efficiency and computational complexity.

Examples herein propose that for a current CU, the MVs for its chroma blocks are refined using the reconstructed luma block if the luma block is coded first, or MVs for the luma block are refined using the reconstructed chroma blocks if the chroma block is coded first. Encoder and decoder should be able to derive the same refined MV for the chroma blocks or luma block for a current CU without additional signaling.

Chroma motion using reconstructed luma blocks is described as follows. In one embodiment, for a current CU in inter-coding mode, if its luma block is coded first with MV=MVP+MVD, the luma MV may be refined for the chroma blocks by comparing the reconstructed luma block with the prediction luma blocks pointed to by a few MVs around the luma MV within a small refinement area. The small refinement area should be pre-determined at both the encoder and decoder. The (e.g., small) refinement area should be around the MV used for the luma block. For example, plus or minus one pixel (e.g., in horizontal and vertical directions) around the MV. Practically, the size should be small (e.g., one to a few pixels around the MV) to save the runtime.

Among the refined MVs, the one with the smallest difference (e.g., SAD) between its corresponding prediction luma block and the reconstructed luma block of the current CU is selected and used for coding the chroma blocks of the current CU.

FIG. 3 shows an example, where block c 310-c is the reconstructed (recon) luma block of the current CU (c) and block p 310-p is the prediction luma block pointed to by MV 220=MVP+MVD. See block 350, where the luma block is coded first with MV=MVP+MVD. Instead of using this same luma MV 220 for chroma blocks, the encoder and decoder can refine (see block 360) the luma MV within a small refinement area 330 by creating refined MVs 340 by adding refinements 375 (e.g., one or more values of a vector) to the luma MV 220 where the refined MVs 340 are contained within the refinement arca 330, and by comparing the reconstructed luma block c 310-c and the prediction luma blocks 310-p* pointed to by the refined MVs 340. The refined MV 340 with (that is, that creates) the smallest difference (e.g., using SAD) between the corresponding prediction luma block 310-p* and the reconstructed luma block c 310-c is then used for coding the chroma blocks of the current CU. See block 370.

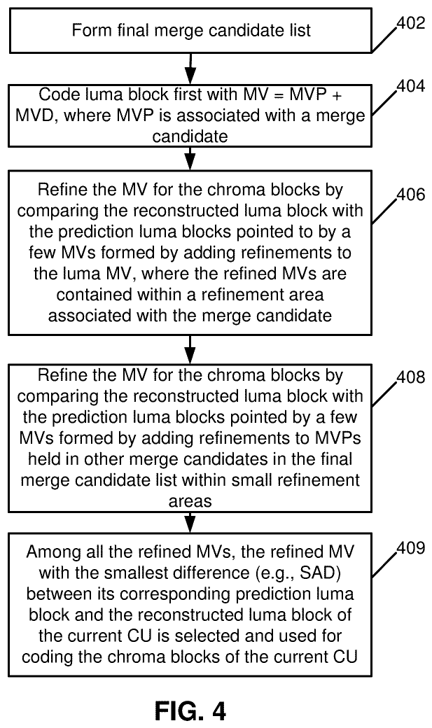

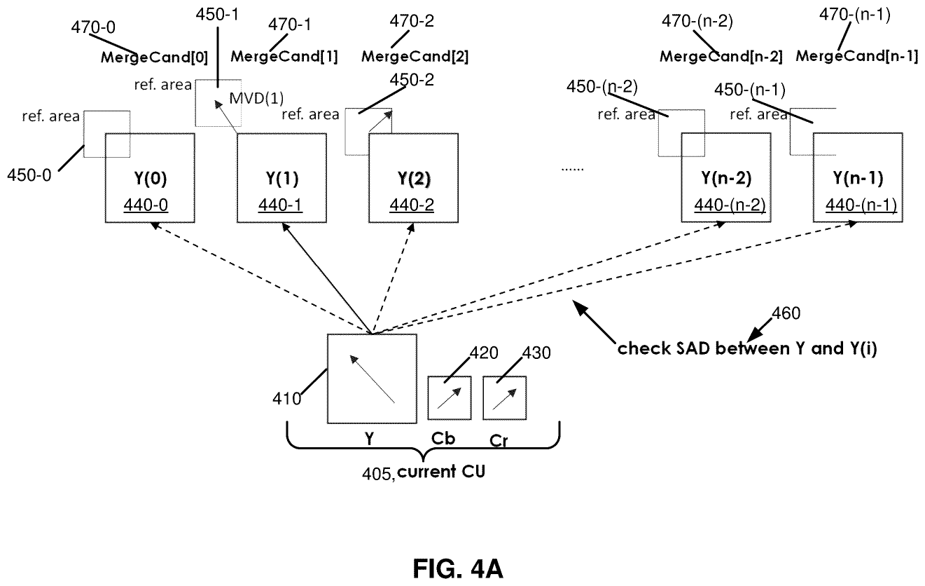

In one embodiment, see FIG. 4, which is a flowchart of a method for chroma motion vector refinement using reconstructed luma in one example. The method in FIG. 4 would be performed as part of an inter-frame prediction process for frames of video, for encoding or decoding. In block 402, it is assumed the final merge candidate list has or is formed. In block 404, for a current CU in inter-coding mode, if its luma block is coded first with MV=MVP+MVD, the MVP is associated with a merge candidate. The MV may be refined (block 406) for the chroma blocks by comparing the reconstructed luma block with the prediction luma blocks pointed to by a few MVs formed by adding refinements to the luma MV, where the refined MVs are contained within a refinement area associated with the merge candidate, as well as (see block 408) with the prediction luma blocks pointed to by a few MVs formed by adding refinements to MVPs held in (e.g., associated with) other merge candidates in the final merge candidate list within small refinement areas for the other merge candidates. The small refinement areas should be pre-determined at both encoder and decoder so that both use the same small refinement areas for refinement. As mentioned above, if the refinement area is set to 1×1 pixels window, there can be about 7×7 possible ¼ (one quarter) pel motion vector positions, which can be refinement(s) 375. Encoder and decoder may check all or some of those possible ¼ pel MVs (e.g., as refinements 375) within the refinement area. Both the refinement area and a rule on how to search the best ¼ pel MV may have to be pre-determined. In block 409, among all the refined MVs, the refined MV with the smallest difference (e.g., SAD) between its corresponding prediction luma block and the reconstructed luma block of the current CU is selected and used for coding the chroma blocks of the current CU.

FIG. 4A shows an example, where block Y is the luma block 410 of the current CU 405 and blocks Y(i), i=0, 1, . . . , n−1, are the prediction luma blocks 440-0, 440-1, 440-2, . . . 440-(n−2), 440-(n−1) associated with merge candidates MergeCand[i], i=0, 1, . . . , n−1, 470-0, 470-1, 470-2, . . . 470-(n−2), 470-(n−1). In this example, it is assumed that the luma block Y 410 of the current CU 405 is coded with the MV(1) equal to MVP(1) held in merge candidate MergeCand[1]+MVD(1). The chrominance blocks Cb 420 and Cr 430 are also illustrated.

After the luma block 410 is coded, the encoder and decoder compare the reconstructed luma block Y of the current CU with the prediction luma blocks pointed to by the MVs refined around the MV(1)=MVP(1)+MVD(1) within a small refinement (ref.) arca 450-1 as well as the prediction luma blocks 440 pointed to by the MVs refined around MVP(i) held in other merge candidates MergeCand[i] 470, i=0, 2, . . . , n−1, with the small refinement areas 450-0, 450-2, . . . , 450-(n−2), 450-(n−1).

In this example, among all the refined MVs, the MV refined around MVP(2) held in merge candidate MergeCand[2] is the one with the smallest difference (e.g., by checking 460 SAD between every Y and Y(i)) between its prediction luma block and the reconstructed luma block of the current CU. Note that reference 460 of FIG. 4A occurs as part of block 409 of FIG. 4. Hence, the refined MV around MVP(2) held in merge candidate MergeCand[2] is used for the chroma blocks of the current CU. Note that the MV used for the chroma blocks is not necessarily the same as the MV used for the luma block.

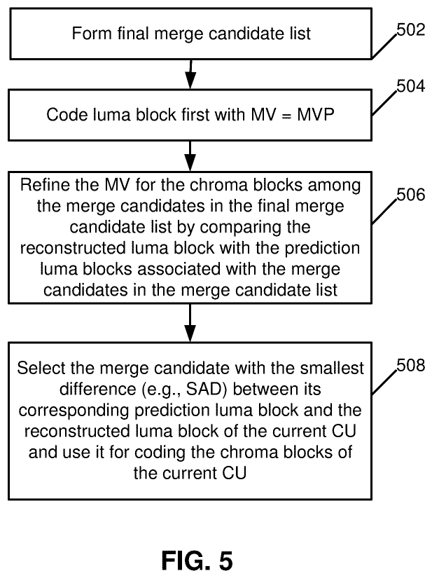

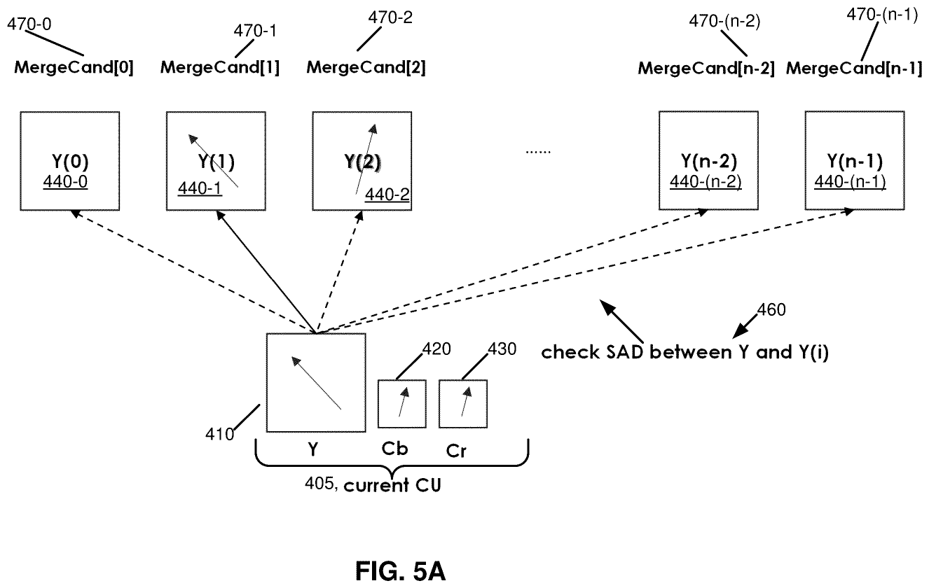

Refer to FIG. 5, which is a flowchart of a method for chroma motion vector refinement using reconstructed luma in one example. The method in FIG. 5 would be performed as part of an inter-frame prediction process for frames of video, for encoding or decoding. In another embodiment, in block 502, the final merge candidate list is (or has been) formed. For a current CU in inter-coding mode, if its luma block is coded first with MV=MVP, as in block 504, the MV for the chroma blocks may be refined (see block 506) among the merge candidates in the merge candidate list by comparing the reconstructed luma block with the prediction luma blocks associated with the merge candidates in the merge candidate list. In block 508, the merge candidate with the smallest difference (e.g., SAD) between its corresponding prediction luma block and the reconstructed luma block of the current CU is selected and used for coding the chroma blocks of the current CU.

FIG. 5A shows an example, where block Y 410 is the luma block of the current CU 405 and blocks Y(i), i=0, 1, . . . , n−1, are the prediction luma blocks 440-0, 440-1, 440-2, . . . 440-(n—2), 440-(n−1) associated with corresponding merge candidates (i), i=0, 1, . . . , n−1, 470-0, 470-1, 470-2, . . . 470-(n−2), 470-(n−1). In this example, it is assumed that the luma block Y 410 of the current CU 405 is coded with merge candidate MergeCand[1] 470-1.

After the luma block (block Y 410) is coded, the encoder and decoder compare the reconstructed luma block Y 410 of the current CU 405 with the prediction luma blocks Y(i) 440, i=0,1, . . . , n−1, associated with the merge candidates MergeCand[i] 470, i=0, 1 . . . , n−1, in the merge candidate list. In this example, among all the merge candidates 470, merge candidate MergeCand[2] 470-2 is the one with the smallest difference between its corresponding prediction luma block and the reconstructed luma block of the current CU. Hence, the MVP held in merge candidate MergeCand[2] 470-2 is used for the chroma blocks 420, 430 of the current CU 405. Note that the MV used for the chroma blocks 420, 430 is not necessarily the same as the MV used for the luma block.

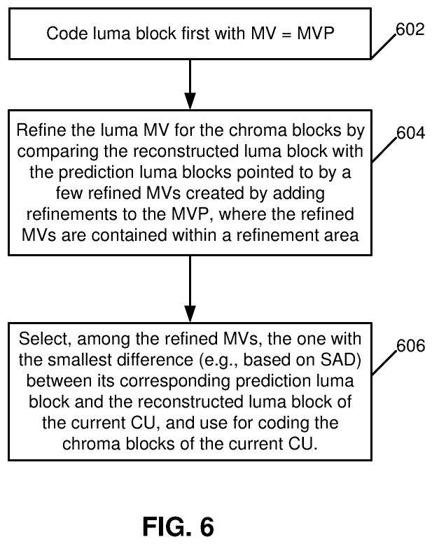

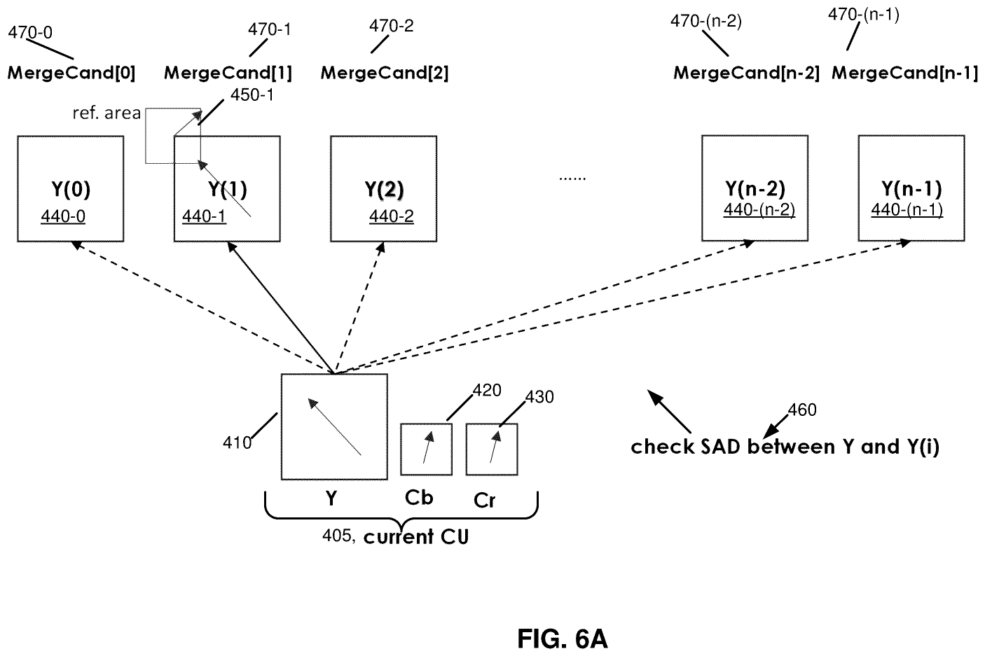

Turn to FIG. 6, which is a flowchart of a method for chroma motion vector refinement using reconstructed luma in one example. The method in FIG. 6 would be performed as part of an inter-frame prediction process for frames of video, for encoding or decoding. In another embodiment, for a current CU in inter-coding mode, if its luma block is coded first with MV=MVP (see block 602), the luma MV may be refined (see block 604) for the chroma blocks by comparing the reconstructed luma block with the prediction luma blocks pointed to by a few refined MVs created by adding refinements to the MVP, where the refined MVs are contained within a refinement area. The small refinement area should be pre-determined at both encoder and decoder. In block 606, among the refined MVs, the one with the smallest difference (e.g., based on SAD) between its corresponding prediction luma block and the reconstructed luma block of the current CU is selected and used for coding the chroma blocks of the current CU.

FIG. 6A shows an example, where block Y 410 is the luma block of the current CU 405 and blocks Y(i), i=0, 1, . . . , n−1, are the prediction luma blocks 440-0, 440-1, 440-2, . . . 440-(n−2), 440-(n−1) associated with merge candidates MergeCand[i], i=0, 1, . . . , n−1, 470-0, 470-1, 470-2, . . . 470-(n−2), 470-(n−1). In this example, it is assumed that the luma block Y 410 of the current CU 405 is coded with merge candidate MergeCand[1] 470-1.

Hence, the MVP held in merge candidate MergeCand[1] 470-1 is refined within a small refinement area 450-1 for the chroma blocks 420, 430 of the current CU 405. Note that the MV used for the chroma blocks 420, 430 is not necessarily the same as the MV used for the luma block.

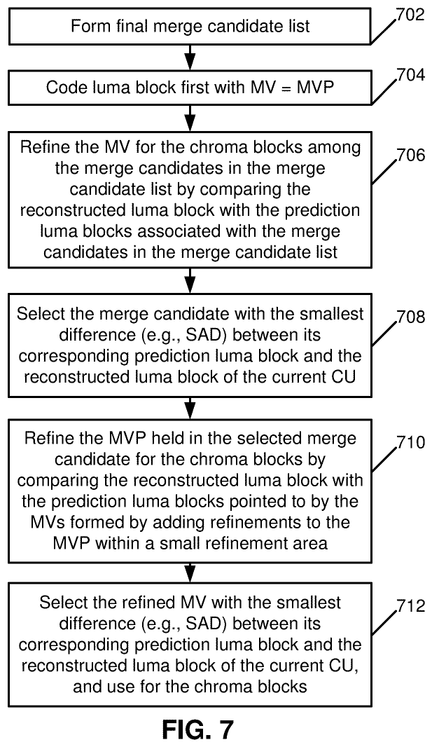

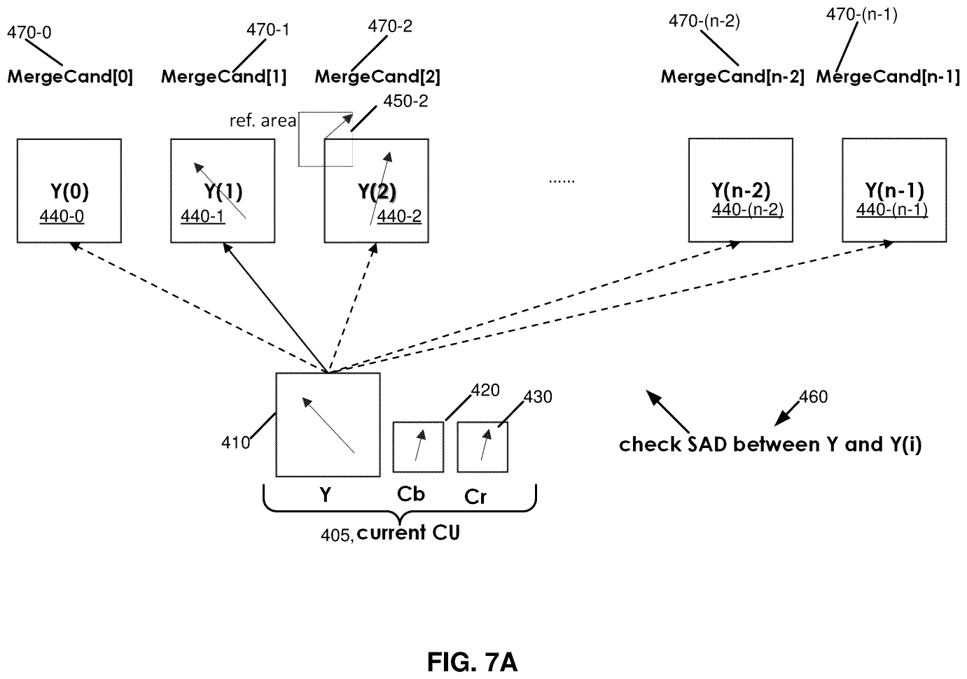

Refer to FIG. 7, which is a flowchart of a method for chroma motion vector refinement using reconstructed luma in one example. The method in FIG. 7 would be performed as part of an inter-frame prediction process for frames of video, for encoding or decoding. In another embodiment, this assumes (see block 702) that a final merge candidate list is (or has been) formed. For a current CU in inter-coding mode, if its luma block is coded first with MV=MVP (see block 704), the MV for the chroma blocks may be refined (see block 706) among the merge candidates in the merge candidate list by comparing the reconstructed luma block with the prediction luma blocks associated with the merge candidates in the merge candidate list. In block 708, the merge candidate with the smallest difference (e.g., SAD) between its corresponding prediction luma block and the reconstructed luma block of the current CU is selected. In block 710, the MVP held in the selected merge candidate may be further refined for the chroma blocks by comparing the reconstructed luma block with the prediction luma blocks pointed to by the MVs formed by adding refinements to the MVP within a small refinement area. That is, the refined MVs are contained within a refinement area associated with the merge candidate. The small refinement area should be pre-determined at both encoder and decoder. In block 712, the refined MV with the smallest difference (e.g., SAD) between its corresponding prediction luma block and the reconstructed luma block of the current CU is selected and used for the chroma blocks.

FIG. 7A shows an example, where block Y 410 is the luma block of the current CU 405 and blocks Y(i), i=0, 1, . . . , n−1, are the prediction luma blocks 440-0, 440-1, 440-2, . . . 440-(n−2), 440-(n−1) associated with merge candidates MergeCand[i], i=0, 1, . . . , n−1, 470-0, 470-1, 470-2, . . . 470-(n−2), 470-(n−1). In this example, it is assumed that the luma block Y 410 of the current CU 405 is coded with merge candidate MergeCand[1] 470-1.

After the luma block is coded, the encoder and decoder compare the reconstructed luma block Y 410 of the current CU 405 with the prediction luma blocks Y(i), i=0,1, . . . , n−1, associated with the merge candidates MergeCand[i], i=0, 1, . . . , n−1, in the merge candidate list. In this example, among all the merge candidates, merge candidate MergeCand[2] 470-2 is the one with the smallest difference between its corresponding prediction luma block and the reconstructed luma block of the current CU. Hence, the MVP held in merge candidate MergeCand[2] 470-2 is refined within a small refinement area 450-2 for the chroma blocks of the current CU. Note that the MV used for the chroma blocks 420, 430 is not necessarily the same as the MV used for the luma block (block Y 410).

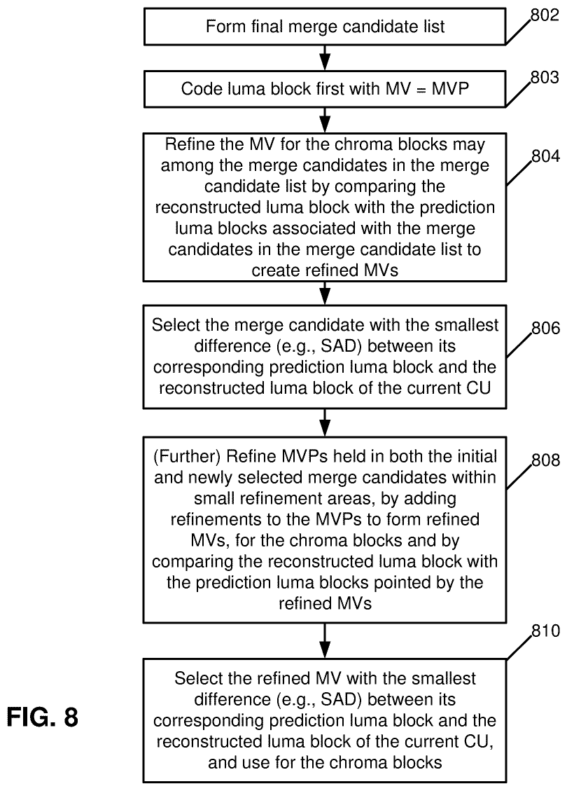

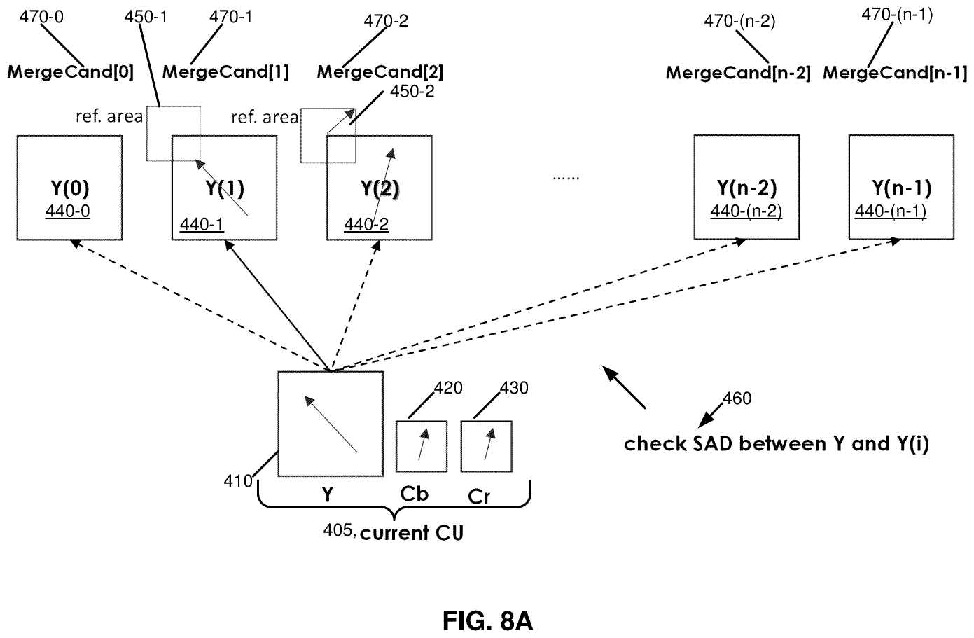

Turn to FIG. 8, which is a flowchart of a method for chroma motion vector refinement using reconstructed luma in one example. The method in FIG. 8 would be performed as part of an inter-frame prediction process for frames of video, for encoding or decoding. In another embodiment, this assumes that, in 802, the final merge candidate list has been formed. For a current CU in inter-coding mode, if its luma block is coded first with MV=MVP (sec block 803), the MV for the chroma blocks may be refined (see block 804) among the merge candidates in the merge candidate list by comparing the reconstructed luma block with the prediction luma blocks associated with the merge candidates in the merge candidate list. In block 806, the merge candidate with the smallest difference (e.g., SAD) between its corresponding prediction luma block and the reconstructed luma block of the current CU is selected. In block 808, the MVPs held in both the initial and newly selected merge candidates may be further refined within small refinement areas for the chroma blocks, by adding refinements to the MVPs to form refined MVs, and by comparing the reconstructed luma block with the prediction luma blocks pointed to by the refined MVs. The small refinement areas should be pre-determined at both encoder and decoder. In block 810, the refined MV with the smallest difference (e.g., SAD) between its corresponding prediction luma block and the reconstructed luma block of the current CU is selected and used for the chroma blocks.

It is noted that, in block 803, MV=MVP, where MVP corresponds to one of merge candidates 440. Block 804 reevaluates all other MVPs associated with other merge candidates 440. A second MV=MVP may be selected. Block 808 refines the first MV=MVP corresponding to the first merge candidate as well as refines the possible second MV=MVP corresponding to a second or newly selected merge candidate. The refined MV(s) may be equal to MVPs if they are still the best ones, but this is not necessary. The refined MV(s) may be slightly different from MVP(s).

FIG. 8A shows an example, where block Y 410 is the luma block of the current CU 405 and blocks Y(i), i=0, 1, . . . , n−1, are the prediction luma blocks 440-0, 440-1, 440-2, . . . 440-(n−2), 440-(n−1) associated with merge candidate MergeCand[i], i=0, 1, . . . , n−1, 470-0, 470-1, 470-2, . . . 470-(n−2), 470-(n−1). In this example, it is assumed that the luma block Y 410 of the current CU 405 is coded with merge candidate MergeCand[1] 470-1.

After the luma block is coded, the encoder and decoder compare the reconstructed luma block Y 410 of the current CU 405 with the prediction luma blocks Y(i), i=0,1, . . . , n−1, associated with the merge candidates MergeCand[i], i=0, 1, . . . , n−1, in the merge candidate list. In this example, among all the merge candidates, merge candidate MergeCand[2] 470-2 is the one with the smallest difference between its corresponding prediction luma block and the reconstructed luma block of the current CU 405. Hence, the MVPs held in both merge candidate MergeCand(1) and merge candidate MergeCand(2) are refined with the small refinement areas 450-1, 450-2 for the chroma blocks 420, 430 of the current CU 405. Note that the MV used for the chroma blocks 420, 430 is not necessarily the same as the MV used for the luma block.

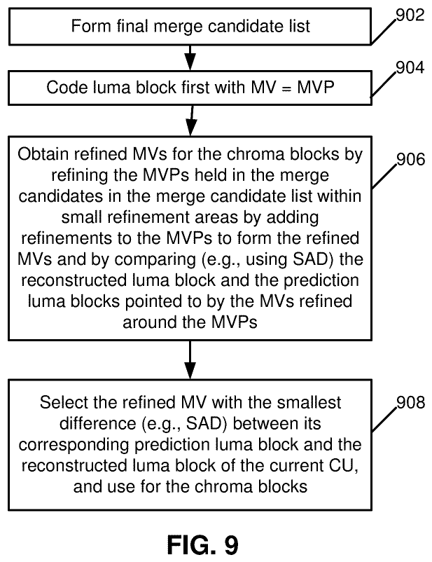

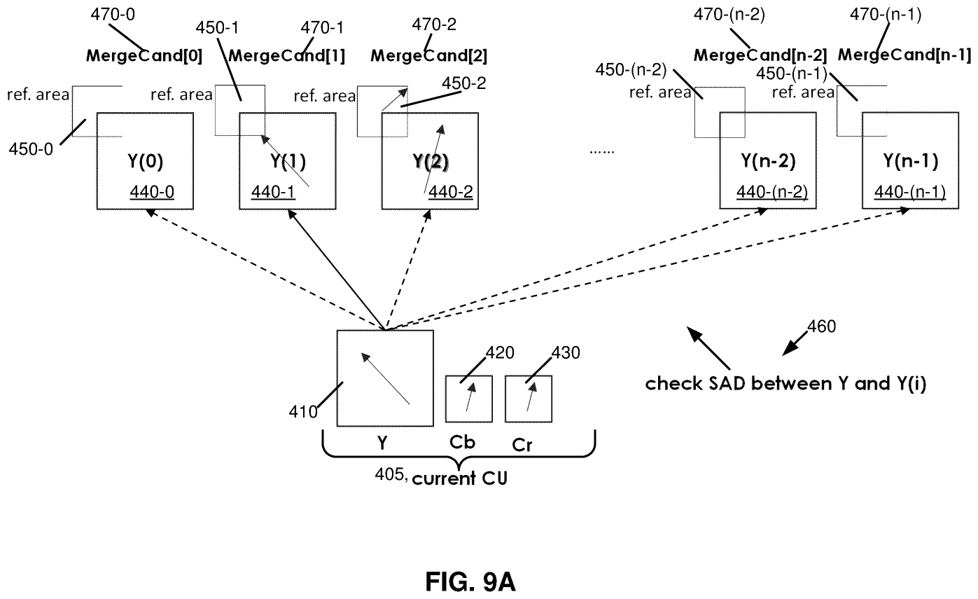

Refer to FIG. 9, which is a flowchart of a method for chroma motion vector refinement using reconstructed luma in one example. The method in FIG. 9 would be performed as part of an inter-frame prediction process for frames of video, for encoding or decoding. In another embodiment, this assumes the final merge candidate list has been (or is) formed in block 902. For a current CU in inter-coding mode, if its luma block is coded first with MV=MVP (see block 904), the MV for the chroma blocks may be obtained by refining (see block 906) the MVPs held in (e.g., associated with) the merge candidates in the merge candidate list within small refinement areas by adding refinements to the MVPs to form the refined MVs and by comparing (e.g., based on differences, e.g., SAD, between) the reconstructed luma block and the prediction luma blocks pointed to by the MVs refined around the MVPs. The small refinement area should be pre-determined at both encoder and decoder. In block 908, the refined MV with the smallest difference (e.g., SAD) between its corresponding prediction luma block and the reconstructed luma block of the current CU is selected and used for the chroma blocks.

FIG. 9A shows an example, where block Y 410 is the luma block of the current CU 405 and blocks Y(i), i=0, 1, . . . , n−1, are the prediction luma blocks 440-0, 440-1, 440-2, . . . 440-(n−2), 440-(n−1) associated with merge candidate MergeCand[i] 470, i=0, 1 . . . , n−1. In this example, it is assumed that the luma block Y 410 of the current CU 405 is coded with merge candidate MergeCand[1] 470-1.

After the luma block is coded, the encoder and decoder refine the MVP (i), i=0, 1, . . . , n−1, held in merge candidates MergeCand[i], i=0, 1, . . . n=1, within small refinement areas based upon the differences (e.g., via comparison) between the reconstructed luma block Y of the current CU and the prediction luma blocks pointed to by the refined MVs refined around the MVPs.

In this example, among all the refined MVs, the one around MVP(2) held in merge candidate MergeCand[2] is the one with the smallest difference between its corresponding prediction luma block and the reconstructed luma block of the current CU. Hence, it is selected and used for the chroma blocks. Note that the MV used for the chroma blocks is not necessarily the same as the MV used for the luma block.

Luma motion using reconstructed chroma blocks is described now. These embodiments indicate that the methods above can be “reversed” by coding the chroma blocks first, then applying the techniques to the chroma blocks to provide coding for the luma block of a current CU.

In one embodiment, for a current CU in inter-coding mode, if its chroma blocks are coded first with MV=MVP+MVD, the chroma MV may be refined for the luma block by comparing the reconstructed chroma blocks with the prediction chroma blocks pointed to by a few MVs around the chroma MV within a small refinement area. The small refinement area should be pre-determined at both encoder and decoder. That is, refining comprises comparing the reconstructed chroma blocks with the prediction chroma blocks pointed to by a few refined MVs created by adding refinements to the chroma MV, where the refined MVs are contained within a refinement area. Among the refined MVs, the one with the smallest difference (e.g., SAD) between its corresponding prediction chroma blocks and the reconstructed chroma blocks of the current CU is selected and used for coding the luma block of the current CU.

In one embodiment, for a current CU in inter-coding mode, if its chroma blocks are coded first with MV=MVP+MVD, the chroma MV may be refined for the luma block by comparing the reconstructed chroma blocks with the prediction chroma blocks pointed to by a few refines MVs around the chroma MV (e.g., by adding refinements to the chroma MV) within a small refinement area as well as with the prediction chroma blocks pointed to by a few refined MVs around the MVPs (e.g., by adding refinements to the MVPs) held in (e.g., associated with) other merge candidates in the final merge candidate list within small refinement areas. That is, the refined MVs are contained within corresponding refinement areas. The small refinement areas should be pre-determined at both encoder and decoder. Among all the refined MVs, the one with the smallest difference (e.g., SAD) between its corresponding prediction chroma blocks and the reconstructed chroma blocks of the current CU is selected and used for coding the luma block of the current CU.

In one embodiment, for a current CU in inter-coding mode, if its chroma blocks are coded first with MV=MVP, the MV for the luma block may be refined (e.g., re-evaluated) among the merge candidates in the merge candidate list by comparing the reconstructed chroma blocks with the prediction chroma blocks associated with the merge candidates in the merge candidate list to refine the chroma MV (e.g., to be used for the luma block). The merge candidate with the smallest difference (e.g., SAD) between its corresponding prediction chroma blocks and the reconstructed chroma block of the current CU is selected and used for coding the luma block of the current CU.

In one embodiment, for a current CU in inter-coding mode, if its chroma blocks are coded first with MV=MVP, the chroma MV may be refined for the luma blocks by comparing the reconstructed chroma blocks with the prediction chroma blocks pointed to by a few refined MVs created by adding refinements to the MVP, wherein the refined MVs are contained within a small refinement area. The small refinement area should be pre-determined at both encoder and decoder. Among the refined MVs, the one with the smallest difference (e.g., SAD) between its corresponding prediction chroma blocks and the reconstructed chroma blocks of the current CU is selected and used for coding the luma blocks of the current CU.

In one embodiment, for a current CU in inter-coding mode, if its chroma blocks are coded first with MV=MVP, the MV for the luma blocks may be refined (e.g., re-evaluated) among the merge candidates in the merge candidate list by comparing the reconstructed chroma blocks with the prediction chroma blocks associated with the merge candidates in the merge candidate list. The merge candidate with the smallest difference (e.g., SAD) between its corresponding prediction chroma blocks and the reconstructed chroma blocks of the current CU is selected.

The MVP held in the selected merge candidate may be further refined for the luma block by comparing the reconstructed chroma blocks with the prediction chroma blocks pointed to by the MVs around the MVP within a small refinement area. The small refinement area should be pre-determined at both encoder and decoder. The refined MV with the smallest difference (e.g., SAD) between its corresponding prediction chroma blocks and the reconstructed chroma blocks of the current CU is selected and used for the luma blocks.

In one embodiment, for a current CU in inter-coding mode, if its chroma blocks are coded first with MV=MVP, the MV for the luma block may be refined (e.g., re-evaluated) among the merge candidates in the merge candidate list by comparing the reconstructed chroma blocks with the prediction chroma blocks associated with the merge candidates in the merge candidate list. The merge candidate with the smallest difference (e.g., SAD) between its corresponding prediction chroma blocks and the reconstructed chroma blocks of the current CU is selected.

The MVPs held in both the initial and newly selected merge candidates may be further refined within small refinement areas for the luma block by comparing the reconstructed chroma blocks with the prediction chroma blocks pointed to by the refined MVs. The refined MVs are contained within corresponding refinement areas. The small refinement areas should be pre-determined at both encoder and decoder. The refined MV with the smallest difference (e.g., SAD) between its corresponding prediction chroma blocks and the reconstructed chroma blocks of the current CU is selected and used for the luma blocks.

In one embodiment, for a current CU in inter-coding mode, if its chroma blocks are coded first with MV=MVP, the MV for the luma block may be obtained by refining the MVPs held in the merge candidates in the merge candidate list within small refinement areas based on differences (e.g., SAD) between the reconstructed chroma blocks and the prediction chroma blocks pointed to by the MVs refined around the MVPs. That is, the refining includes comparing the reconstructed chroma blocks and prediction chroma blocks pointed to by refined MVs created by adding refinements to MVPs associated with merge candidates in a merge candidate list, the refined MVs contained within corresponding refinement areas of the merge candidates. The small refinement areas should be pre-determined at both encoder and decoder. The refined MV with the smallest difference (e.g., SAD) between its corresponding prediction chroma blocks and the reconstructed chroma block of the current CU is selected and used for the luma block.

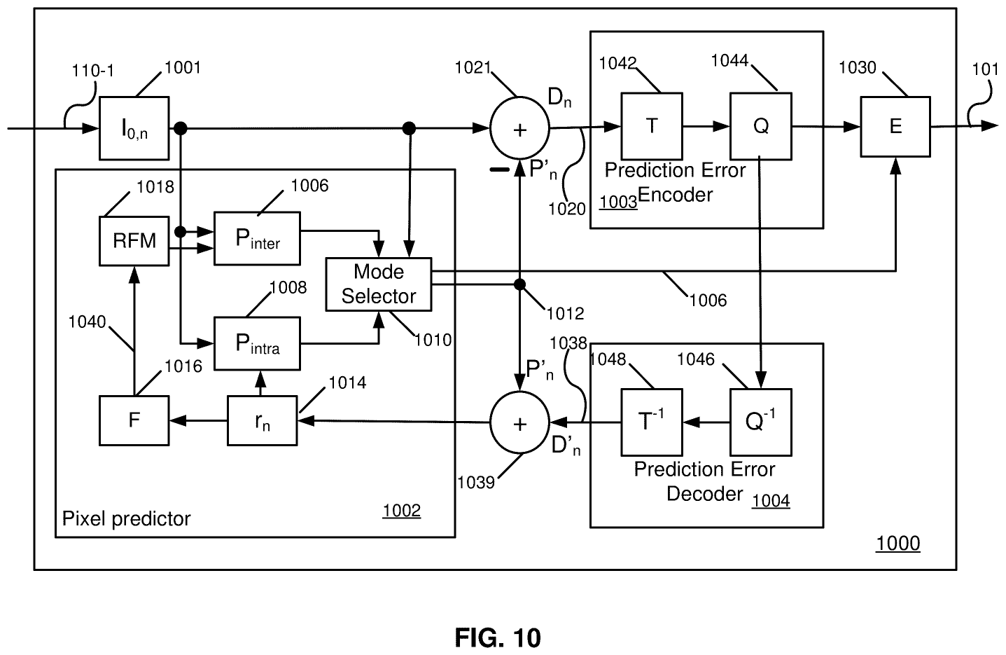

Referring to FIG. 10, this figure illustrates a VVC encoder 1000 where the encoder examples can be implemented. The examples can be implemented at least in part in the inter-predictor (Pᵢₙₜₑᵣ) 1006. It is noted that the terms “image” and “picture” are considered to be the same herein. The encoder 1000 is a base layer and other layers (not shown) may be added to the base layer. The encoder 1000 comprises a pixel predictor 1002, prediction error encoder 1003, and prediction error decoder 1004. FIG. 10 also shows an embodiment of the pixel predictor 1002 as comprising an inter-predictor (Pᵢₙₜₑᵣ) 1006, an intra-predictor (Pᵢₙₜᵣₐ) 1008, a mode selector 1010, a filter (F) 1016, and a reference frame memory (RFM) 1018. The pixel predictor 1002 of the encoder 1000 receives base layer pictures (I_{0,n}) 1001 of input video 110-1 (e.g., a video stream) to be encoded at both the inter-predictor 1006 (which determines the difference between the picture and a motion compensated reference frame from the RFM 1018) and the intra-predictor 1008 (which determines a prediction for an image block based only on the already processed parts of the current picture from a base layer picture 1001). The output of both the inter-predictor 1006 and the intra-predictor 1008 are passed to the mode selector 1010. The intra-predictor 1008 may have more than one intra-prediction mode. Hence, each mode may perform the intra-prediction and provide the predicted signal to the mode selector 1010. The mode selector 1010 also receives a copy of the base layer pictures (I_{0,n}) 1001.

Depending on which encoding mode is selected to encode the current block, the output of the inter-predictor 1006, or the output of one of the intra-predictor 1008 modes, or the output of a surface encoder within the mode selector 1010 is passed to the output of the mode selector 1010. The output of the mode selector 1010 is passed to first summing device 1021 and comprises the prediction representation of the image block (P′ₙ) 1012. The first summing device 1021 may subtract the output 1012 of the pixel predictor 1002 from the base layer picture 1001 to produce a first prediction error signal (Dₙ) 1020, which is input to the prediction error encoder 1003.

The pixel predictor 1002 further receives from a second summing device 1039, which acts as a preliminary reconstructor, the combination of the prediction representation of the image block (P′ₙ) 1012 and the prediction error signal (D′ₙ) 1038 of the prediction error decoder 1004. The preliminary reconstructed picture (rₙ) 1014 may be passed to the intra-predictor 1008 and to a filter (F) 1016. The filter 1016 receiving the preliminary representation may filter the preliminary representation and output a final reconstructed picture 1040, which may be saved in the reference frame memory (RFM) 1018. The reference frame memory 1018 may be connected to the inter-predictor 1006 to be used as the reference picture against which a future base layer picture 1001 is compared in inter-prediction operations.

The prediction error encoder 1003 comprises a transform unit (T) 1042 and a quantizer (Q) 1044. The transform unit 1042 transforms the first prediction error signal 1020 to a transform domain. The transform is, for example, the DCT (discrete cosine transform). The quantizer 1044 quantizes the transform domain signal, e.g., the DCT coefficients, to form quantized coefficients.

The prediction error decoder 1004 receives the output from the prediction error encoder 1003, and performs the opposite processes of the prediction error encoder 1003 to produce a decoded prediction error signal (D′ₙ) 1038 which, when combined with the prediction representation of the image block 1012 at the second summing device 1039, produces the preliminary reconstructed picture 1014. The prediction error decoder 1004 may be considered to comprise a dequantizer (Q⁻¹) 1046, which dequantizes the quantized coefficient values, e.g., DCT coefficients, to reconstruct the transform signal and an inverse transformation unit (T⁻¹) 1048, which performs the inverse transformation to the reconstructed transform signal wherein the output of the inverse transformation unit 1048 contains reconstructed block(s). The prediction error decoder 1004 may also comprise a block filter (not shown) which may filter the reconstructed block(s) according to further decoded information and filter parameters.

The entropy encoder 1030 receives the output of the prediction error encoder 1003 and may perform a suitable entropy encoding/variable length encoding to provide error detection and correction capability. The output of the entropy encoder 1030 can be influenced by the signaling 1006 from the mode selector 1010, e.g., which can indicate, e.g., whether inter prediction or intra prediction is being used. The output of the entropy encoder 1030 may be inserted into a bitstream 101. Entropy coding/decoding may be performed in many ways. For example, context-based coding/decoding may be applied, where in both the encoder and the decoder modify the context state of a coding parameter based on previously coded/decoded coding parameters. Context based coding may for example be context adaptive binary arithmetic coding (CABAC), or context-based variable length coding (CAVLC) or any similar entropy coding. Entropy coding/decoding may alternatively or additionally be performed using a variable length coding scheme, such as Huffman coding/decoding or Exp-Golomb coding/decoding. Decoding of coding parameters from an entropy-coded bitstream or codewords may be referred to as parsing.

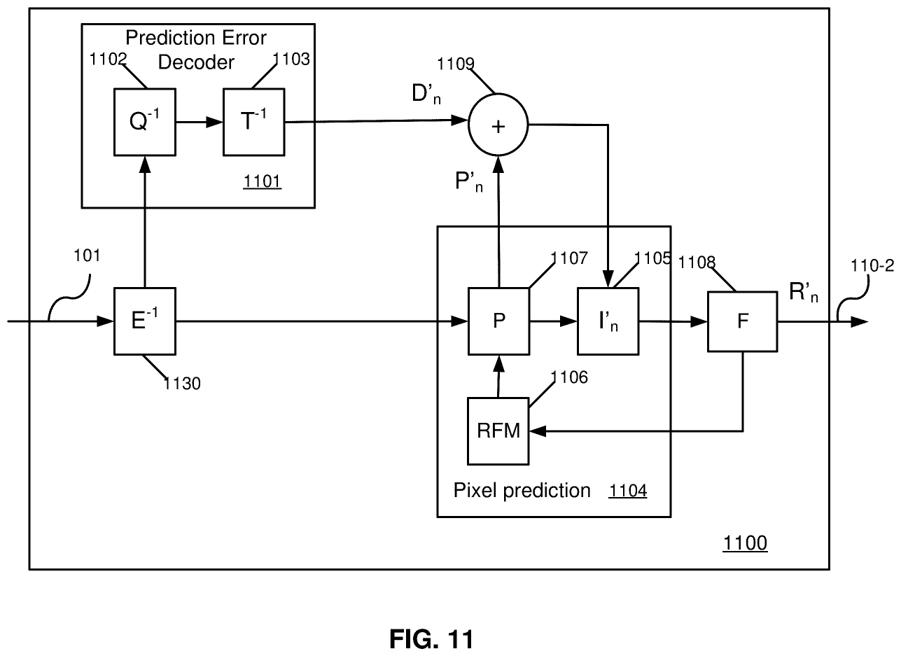

Referring to FIG. 11, this figure illustrates a VVC decoder 1100 where the decoder examples can be implemented. The video decoder 1100 is coupled to the bitstream 101. The examples herein can be implemented at least in part in the block 1107, which illustrates prediction (P) (either inter-prediction or intra-prediction). There is a prediction error decoder 1101 and a pixel prediction 1104. For the prediction error decoder 1101, block 1103 illustrates inverse transforms (T⁻¹), and block 1102 illustrates inverse quantization (Q⁻¹). Block 1130 illustrates entropy decoding (E⁻¹) that has an output for the pixel prediction 1104. Reference P′ₙ stands for a predicted representation of an image block. Reference D′ₙ stands for a reconstructed prediction error signal. In pixel prediction 1104, block 1105 illustrates preliminary reconstructed pictures (I′ₙ) based on the P′ₙ from block 1107 and the output of the adder 1109, block 1107 illustrates prediction (P) (either inter-prediction or intra-prediction), which produces P′ₙ for the adder 1109 and as the block 1105. Block 1130 illustrates entropy decoding (E⁻¹). and block 1106 illustrates a reference frame memory (RFM). Adder 1109 may be used to combine decoded prediction error information (D′ₙ) with predicted base layer/predicted layer pictures (P′ₙ) to obtain the preliminary reconstructed pictures (I′ₙ) 1105. Block 1108 illustrates filtering (F) and reference R′ₙ stands for a final reconstructed picture in an output video (e.g., stream) 110-2.

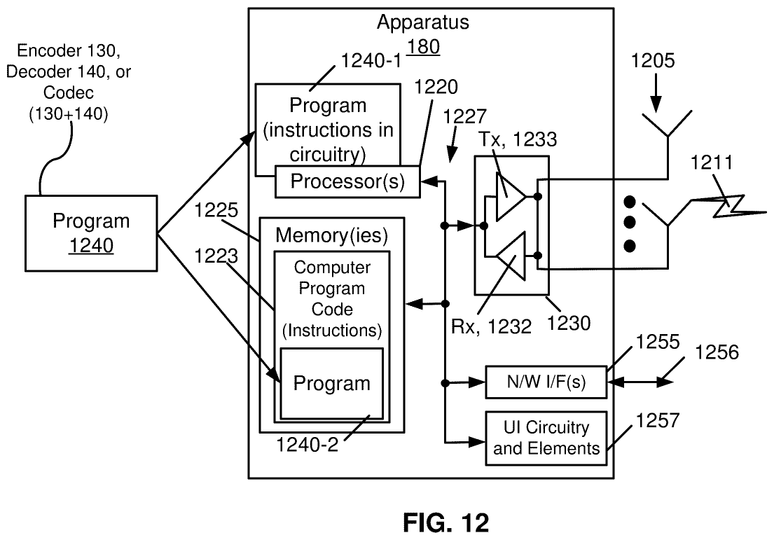

Turning to FIG. 12, this figure is an example of a block diagram of an apparatus 180 suitable for implementing any of the encoders or decoders described herein. The apparatus 180 includes circuitry comprising one or more processors 1220, one or more memories 1225, one or more transceivers 1230, one or more network (N/W) interface(s) (I/F(s)) 1255 and user interface (UI) circuitry and elements 1257, interconnected through one or more buses 1227. Depending on implementation, some apparatus may not have all of the circuitry. For example, an apparatus 180 might not have UI circuitry and elements 1257. An apparatus may have additional circuitry, not described here. FIG. 12 is presented merely as an example.

Each of the one or more transceivers 1230 includes a receiver, Rx, 1232 and a transmitter, Tx, 1233. The one or more buses 1227 may be address, data, and/or control buses, and may include any interconnection mechanism, such as a series of lines on a motherboard or integrated circuit, fiber optics or other optical communication equipment, and the like. The one or more transceivers 1230 are connected to one or more antennas 1205, and may communicate using wireless link 1211, which could implement any number of wireless communication interfaces such as Wi-Fi, cellular, or satellite.

The one or more memories 1225 include computer program code 1223. The apparatus 180 includes a program 1240, comprising one of or both parts 1240-1 and/or 1240-2. The program 1240 may implement an encoder 130, a decoder 140, or a codec (130+140), which implements both encoding and decoding. The program itself may be implemented in a number of ways. The program 1240 may be implemented in circuitry as program 1240-1, such as being implemented as part of the one or more processors 1220, and contains instructions implemented in circuitry. The program 1240-1 may be implemented also as an integrated circuit or through other circuitry such as a programmable gate array. In another example, the program 1240 may be implemented as program 1240-2, which is implemented as computer program code (having corresponding instructions) 1223 and is executed by the one or more processors 1220. For instance, the one or more memories 1225 store instructions that, when executed by the one or more processors 1220, cause the apparatus 180 to perform one or more of the operations as described herein.

The network interface(s) (N/W I/F(s)) 1255 are wired interfaces communicating using link(s) 1256, which could be fiber optic or other wired interfaces. The apparatus 180 could include only wireless transceiver(s) 1230, only N/W I/Fs 1255, or both wireless transceiver(s) 1230 and N/W I/Fs 1255.

The apparatus 180 may or may not include UI circuitry and elements 1257. These could include a display such as a touchscreen, speakers, or interface elements such as for headsets. For instance, an apparatus 180 of a smartphone would typically include at least a touchscreen and speakers. The UI circuitry and elements 1257 may also include circuity to communicate with external UI elements (not shown) such as displays, keyboards, mice, headsets, and the like.

The computer readable memories 1225 may be of any type suitable to the local technical environment and may be implemented using any suitable data storage technology, such as semiconductor-based memory devices, flash memory, firmware, magnetic memory devices and systems, optical memory devices and systems, fixed memory and removable memory. The processor(s) 1220 may be of any type suitable to the local technical environment, and may include one or more of general-purpose computers, special purpose computers, microprocessors, digital signal processors (DSPs) and processors based on a multi-core processor architecture, as non-limiting examples. The processor(s) 1220 control the apparatus 180 to perform the operations as described herein. The processor(s) 1220 may execute instructions, including microcode, but are not implemented solely in software.

Turning to FIG. 13, this figure is a flowchart of a method for encoding a video using chroma motion vector refinement using reconstructed luma in accordance with an example. In block 1305, an encoder 130 receive/accesses video 110-1 having frames. The encoder 130 splits individual frames of video into blocks in block 1310. In block 1320, the encoder 130 processes blocks by intra-and inter-frame predictions. For the inter-frame predictions, the encoder 130 performs the method of one of FIGS. 3, 4, 5, 6, 7, 8, or 9, or corresponding “reversed” techniques using by coding the chroma blocks first, then applying the techniques to the chroma blocks to provide coding for the luma block of a current CU. See block 1330. In block 1340, the encoder 130 performs other processing on blocks until an (encoded) bitstream 101 is formed. The encoder 130 outputs the (encoded) bitstream in block 1350.

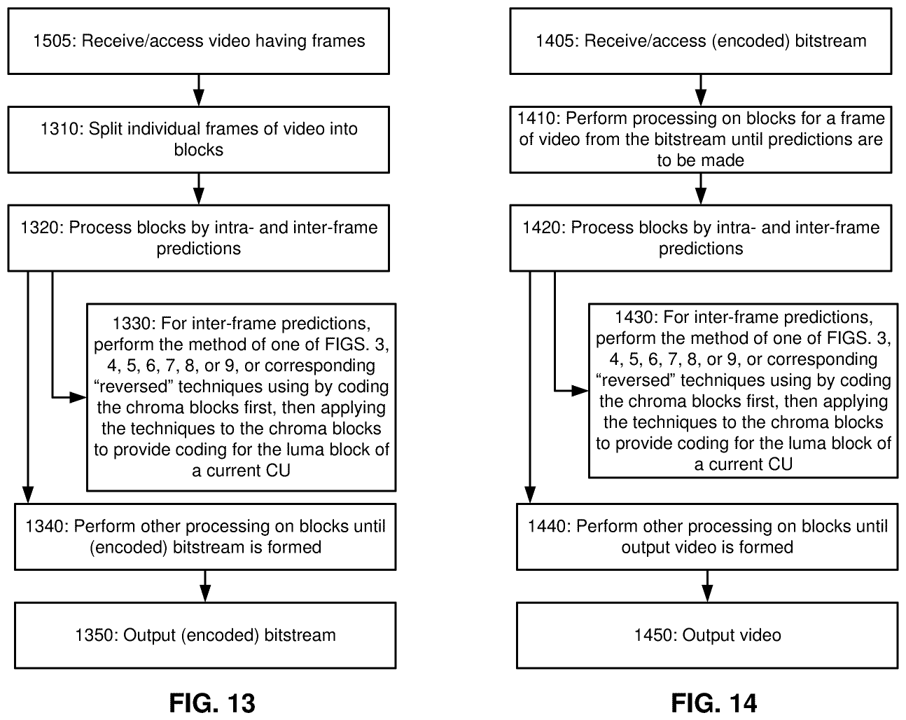

FIG. 14 is a flowchart of a method for decoding a video using chroma motion vector refinement using reconstructed luma in accordance with an example. In block 1405, a decoder 140 receive/accesses an (encoded) bitstream 101. In block 1410, the decoder performs processing on blocks for a frame of video from the bitstream until predictions are to be made. In block 1420, the decoder 140 processes blocks by intra-and inter-frame predictions. For the inter-frame predictions, the decoder 140 performs the method (see block 1430) of one of FIGS. 3, 4, 5, 6, 7, 8, or 9, or corresponding “reversed” techniques using by coding the chroma blocks first, then applying the techniques to the chroma blocks to provide coding for the luma block of a current CU. In block 1440, the decoder 140 performs other processing on blocks until output video is formed, and in block 1450, the decoder 140 outputs the video 110-2.

The following are additional examples.

Example 1. A method, comprising: in an inter-frame prediction process for frames of video, selecting a luma block to be coded first for a current coding unit to form a reconstructed luma block of the current coding unit; refining one or more motion vectors that point from the luma block to a prediction luma block in a reference picture of the video; and selecting one of the refined one or more motion vectors to code chroma blocks for the current coding unit.

Example 2. The method according to example 1, wherein: the luma block is coded with a luma motion vector equal to a motion vector prediction added to a motion vector difference, the luma motion vector corresponding to the selected luma block; the refining comprises creating refined motion vectors by adding refinements to the luma motion vector, where the refined motion vectors are contained within a refinement area; the refining comprises comparing the reconstructed luma block and prediction luma blocks pointed to by the refined motion vectors; a refined motion vector is selected that creates a smallest difference between the reconstructed luma block and a corresponding prediction luma block for the refined motion vector; and the selecting comprises using the selected refined motion vector to code the chroma blocks of the current coding unit.

Example 3. The method according to example 1, wherein: the luma block is coded with a luma motion vector equal to a motion vector prediction added to a motion vector difference, the luma motion vector corresponding to the selected luma block, where the motion vector prediction is associated with a merge candidate from a merge candidate list; the refining comprises: comparing the reconstructed luma block with prediction luma blocks pointed to by a few refined motion vectors formed by adding refinements to the luma motion vector, where the refined motion vectors are contained within a refinement area associated with the merge candidate; and comparing the reconstructed luma block with prediction luma blocks pointed to by a few refined motion vectors formed by adding refinements to motion vector predictions associated with other merge candidates in the merge candidate list within corresponding refinement areas; and one of the refined motion vectors, having a smallest difference between its corresponding prediction luma block and the reconstructed luma block of the current coding unit, is selected and the selected refined motion vector is used to code the chroma blocks of the current coding unit.

Example 4. The method according to example 1, wherein: the luma block is coded with a luma motion vector equal to a motion vector prediction, the luma motion vector corresponding to the selected luma block; the refining comprises comparing the reconsructed luma block with prediction luma block associated with merge candidates in a merge candidate list; and a merge candidate, having a smallest difference between its corresponding prediction luma block and the reconstructed luma block of the current coding unit, is selected and the selected merge candidate is used to code the chroma blocks of the current coding unit.

Example 5. The method according to example 1, wherein: the luma block is coded with a luma motion vector equal to a motion vector prediction, the luma motion vector corresponding to the selected luma block; the refining comprises comparing the reconstructed luma block with prediction luma blocks pointed to by a few refined motion vectors created by adding refinements to the motion vector prediction, where the refined motion vectors are contained within a refinement area; and one of the refined motion vectors, having a smallest difference between its corresponding prediction luma block and the reconstructed luma block of the current coding unit, is selected, and the selected refined motion vector is used to code the chroma blocks of the current coding unit.

Example 6. The method according to example 1, wherein: the luma block is coded with a luma motion vector equal to a motion vector prediction, the luma motion vector corresponding to the selected luma block; the refining comprises comparing the reconstructed luma block with prediction luma blocks associated with merge candidates in a merge candidate list; the method further comprises selecting a merge candidate with a smallest difference between its corresponding prediction luma block and the reconstructed luma block of the current coding unit; refining also comprises comparing the reconstructed luma block with prediction luma blocks pointed to by refined motion vectors formed by adding refinements to the motion vector prediction associated with the selected merge candidate, where the refined motion vectors are contained within a refinement area associated with the merge candidate; and one of the refined motion vectors, having a smallest difference between its corresponding prediction luma block and the reconstructed luma block of the current coding unit, is selected and the selected refined motion vector is used for the chroma blocks to code the current coding unit.

Example 7. The method according to example 1, wherein: the luma block is coded with a luma motion vector equal to a motion vector prediction, the luma motion vector corresponding to the selected luma block that is coded with an initial merge candidate from a merge candidate list; the refining comprises comparing the reconstructed luma block with prediction luma blocks associated with merge candidates in the merge candidate list; the method further comprises selecting a merge candidate with a smallest difference between its corresponding prediction luma block and the reconstructed luma block of the current coding unit; motion vector predictions held in both the initial merge candidate and selected merge candidate are refined by adding refinements to the motion vector predictions to form refined motion vectors and by comparing the reconstructed luma block with prediction luma blocks pointed to by the refined motion vectors, where the refined motion vectors are contained within refinement areas associated with the initial merge candidate or selected merge candidate; and a refined motion vector, having a smallest difference between its corresponding prediction luma block and the reconstructed luma block of the current coding unit, is selected and the selected refined motion vector is used for the chroma blocks to code the current coding unit.

Example 8. The method according to example 1, wherein: the luma block is coded with a luma motion vector equal to a motion vector prediction, the luma motion vector corresponding to the selected luma block that is coded with an initial merge candidate from a merge candidate list; the refining comprises obtaining refined motion vectors by refining the motion vector predictions associated with merge candidates in the merge candidate list within corresponding refinement areas by adding refinements to the motion vector predictions to form the refined motion vectors and by comparing the reconstructed luma block and prediction luma blocks pointed to by the refined motion vectors; and one of the refined motion vectors, having a smallest difference between its corresponding prediction luma block and the reconstructed luma block of the current coding unit, is selected, and the selected refined motion vector is used for the chroma blocks to code the current coding unit.

Example 9. The method according to any of examples 2, 3, and 5 to 8, wherein the inter-frame prediction process for frames of video is performed by an encoder, and wherein refinement areas are pre-determined at both the encoder and a decoder so that both the encoder and decoder use same refinement areas for the refining the one or more motion vectors.

Example 10. A method, comprising: in an inter-frame prediction process for frames of video, selecting chroma blocks to be coded first for a current coding unit to form reconstructed chroma blocks of the current coding unit; refining one or more motion vectors that point from the reconstructed chroma blocks to prediction chroma blocks in a reference picture of the video; and selecting one of the refined one or more motion vectors to code a luma block for the current coding unit.

Example 11. The method according to example 10, wherein: the chroma blocks are coded with a chroma motion vector equal to a motion vector prediction added to a motion vector difference the chroma motion vector corresponding to both chroma blocks; the refining comprises comparing the reconstructed chroma blocks with prediction chroma blocks pointed to by a few refined motion vectors created by adding refinements to the chroma motion vector, where the refined motion vectors are contained within a refinement area; and one of the refined motion vectors, having a smallest difference between its corresponding prediction chroma blocks and the reconstructed chroma blocks of the current coding unit, and the selected refined motion vector is used for coding the luma block of the current coding unit.

Example 12. The method according to example 10, wherein: the chroma blocks are coded with a chroma motion vector equal to a motion vector prediction added to a motion vector difference, the chroma motion vector corresponding to both chroma blocks; the refining comprises comparing the reconstructed chroma blocks with prediction chroma blocks pointed to by a few refined motion vectors created by adding refinements to the chroma motion vector, where the refined motion vectors are contained within a refinement area, as well as with the prediction chroma blocks pointed to by a few refined motion vectors created by adding refinements to motion vector predictions, associated with other merge candidates in a final merge candidate list, and contained within corresponding refinement areas; and one of the refined motion vectors, having a smallest difference between its corresponding prediction chroma blocks and the reconstructed chroma blocks of the current coding unit, is selected, and the selected refined motion vector is used for coding the luma block of the current coding unit.

Example 13. The method according to example 10, wherein: the chroma blocks are coded with a chroma motion vector equal to a motion vector prediction, the chroma motion vector corresponding to both chroma blocks; the refining comprises comparing reconstructed chroma blocks with prediction chroma blocks associated with merge candidates in a merge candidate list; and a merge candidate, having a smallest difference between its corresponding prediction chroma blocks and the reconstructed chroma blocks of the current coding unit, is selected and the selected merge candidate is used for coding the luma block of the current coding unit.

Example 14. The method according to example 10, wherein: the chroma blocks are coded with a chroma motion vector equal to a motion vector prediction, the chroma motion vector corresponding to both chroma blocks; the refining comprises comparing the reconstructed chroma blocks with prediction chroma blocks pointed to by a few refined motion vectors created by adding refinements to the motion vector prediction, where the refined motion vectors are contained within a refinement area; and one of the refined motion vectors, having a smallest difference between its corresponding prediction chroma blocks and the reconstructed chroma blocks of the current coding unit, is selected, and the selected refined motion vector is used for coding the luma blocks of the current coding unit.

Example 15. The method according to example 10, wherein: the chroma blocks are coded with a chroma motion vector equal to a motion vector prediction, the chroma motion vector corresponding to both chroma blocks; the refining comprises comparing the reconstructed chroma blocks with prediction chroma blocks associated with merge candidates in a merge candidate list; and a merge candidate, having a smallest difference between its corresponding prediction chroma blocks and the reconstructed chroma blocks of the current coding unit, is selected.

Example 16. The method according to example 15, wherein: the refining comprises comparing the reconstructed chroma blocks with prediction chroma blocks pointed to by refined motion vectors created by adding refinements to the motion vector prediction in the selected merge candidate, the refined motion vectors contained within a refinement area; and one of the refined motion vectors, having a smallest difference between its corresponding prediction chroma blocks and the reconstructed chroma blocks of the current coding unit, is selected, and the selected refined motion vector is used for the luma block of the current coding unit.

Example 17. The method according to example 10, wherein: the chroma blocks are coded with a chroma motion vector equal to a motion vector prediction, the chroma motion vector corresponding to both chroma blocks; the refining comprises comparing the reconstructed chroma blocks with prediction chroma blocks associated with merge candidates in a merge candidate list; and a merge candidate, having a smallest difference between its corresponding prediction chroma blocks and the reconstructed chroma blocks of the current coding unit, is selected, and the selected merge candidate is used for coding the luma block of the current coding unit.

Example 18. The method according to example 10, wherein: the refining comprises comparing the reconstructed chroma blocks with prediction chroma blocks pointed to by refined motion vectors created by adding refinements to motion vector predictions held in both an initial merge candidate and a selected merge candidate, wherein the refined motion vectors are contained within corresponding refinement areas; and one of the refined motion vectors, having a smallest difference between its corresponding prediction chroma blocks and the reconstructed chroma blocks of the current coding unit, is selected, and the selected refined motion vector is used for coding the luma block of the current coding unit.

Example 19. The method according to example 10, wherein: the chroma blocks are coded with a chroma motion vector equal to a motion vector prediction, the chroma motion vector corresponding to both chroma blocks; the refining comprises comparing the reconstructed chroma blocks and prediction chroma blocks pointed to by refined motion vectors created by adding refinements to motion vector predictions associated with merge candidates in a merge candidate list, the refined motion vectors contained within corresponding refinement areas of the merge candidates; and one of the refined motion vectors, having a smallest difference between its corresponding prediction chroma blocks and the reconstructed chroma block of the current coding unit, is selected, and the selected refined motion vector is used for coding the luma block of the current coding unit.

Example 20. The method according to any of examples 11, 12, 14, 15, 18, or 19, wherein the inter-frame prediction process for frames of video is performed by an encoder, and wherein refinement areas are pre-determined at both the encoder and a decoder so that both use same refinement areas for the refining the one or more motion vectors.

Example 21. An apparatus, comprising means for: in an inter-frame prediction process for frames of video, selecting a luma block to be coded first for a current coding unit to form a reconstructed luma block of the current coding unit; refining one or more motion vectors that point from the luma block to a prediction luma block in a reference picture of the video; and selecting one of the refined one or more motion vectors to code chroma blocks for the current coding unit.

Example 22. The apparatus according to example 21, wherein: the luma block is coded with a luma motion vector equal to a motion vector prediction added to a motion vector difference, the luma motion vector corresponding to the selected luma block; the refining comprises creating refined motion vectors by adding refinements to the luma motion vector, where the refined motion vectors are contained within a refinement area; the refining comprises comparing the reconstructed luma block and prediction luma blocks pointed to by the refined motion vectors; a refined motion vector is selected that creates a smallest difference between the reconstructed luma block and a corresponding prediction luma block for the refined motion vector; and the selecting comprises using the selected refined motion vector to code the chroma blocks of the current coding unit.

Example 23. The apparatus according to example 21, wherein: the luma block is coded with a luma motion vector equal to a motion vector prediction added to a motion vector difference, the luma motion vector corresponding to the selected luma block, where the motion vector prediction is associated with a merge candidate from a merge candidate list; the refining comprises: comparing the reconstructed luma block with prediction luma blocks pointed to by a few refined motion vectors formed by adding refinements to the luma motion vector, where the refined motion vectors are contained within a refinement area associated with the merge candidate; and comparing the reconstructed luma block with prediction luma blocks pointed to by a few refined motion vectors formed by adding refinements to motion vector predictions associated with other merge candidates in the merge candidate list within corresponding refinement areas; and one of the refined motion vectors, having a smallest difference between its corresponding prediction luma block and the reconstructed luma block of the current coding unit, is selected and the selected refined motion vector is used to code the chroma blocks of the current coding unit.

Example 24. The apparatus according to example 21, wherein: the luma block is coded with a luma motion vector equal to a motion vector prediction, the luma motion vector corresponding to the selected luma block; the refining comprises comparing the reconstructed luma block with prediction luma blocks associated with merge candidates in a merge candidate list; and a merge candidate, having a smallest difference between its corresponding prediction luma block and the reconstructed luma block of the current coding unit, is selected and the selected merge candidate is used to code the chroma blocks of the current coding unit.

Example 25. The apparatus according to example 21, wherein: the luma block is coded with a luma motion vector equal to a motion vector prediction, the luma motion vector corresponding to the selected luma block; the refining comprises comparing the reconstructed luma block with prediction luma blocks pointed to by a few refined motion vectors created by adding refinements to the motion vector prediction, where the refined motion vectors are contained within a refinement area; and one of the refined motion vectors, having a smallest difference between its corresponding prediction luma block and the reconstructed luma block of the current coding unit, is selected, and the selected refined motion vector is used to code the chroma blocks of the current coding unit.

Example 26. The apparatus according to example 21, wherein: the luma block is coded with a luma motion vector equal to a motion vector prediction, the luma motion vector corresponding to the selected luma block; the refining comprises comparing the reconstructed luma block with prediction luma blocks associated with merge candidates in a merge candidate list; the means are further configured for selecting a merge candidate with a smallest difference between its corresponding prediction luma block and the reconstructed luma block of the current coding unit; refining also comprises comparing the reconstructed luma block with prediction luma blocks pointed to by refined motion vectors formed by adding refinements to the motion vector prediction associated with the selected merge candidate, where the refined motion vectors are contained within a refinement area associated with the merge candidate; and one of the refined motion vectors, having a smallest difference between its corresponding prediction luma block and the reconstructed luma block of the current coding unit, is selected and the selected refined motion vector is used for the chroma blocks to code the current coding unit.

Example 27. The apparatus according to example 21, wherein: the luma block is coded with a luma motion vector equal to a motion vector prediction, the luma motion vector corresponding to the selected luma block that is coded with an initial merge candidate from a merge candidate list; the refining comprises comparing the reconstructed luma block with prediction luma blocks associated with merge candidates in the merge candidate list; the means are further configured for selecting a merge candidate with a smallest difference between its corresponding prediction luma block and the reconstructed luma block of the current coding unit; motion vector predictions held in both the initial merge candidate and selected merge candidate are refined by adding refinements to the motion vector predictions to form refined motion vectors and by comparing the reconstructed luma block with prediction luma blocks pointed to by the refined motion vectors, where the refined motion vectors are contained within refinement areas associated with the initial merge candidate or selected merge candidate; and a refined motion vector, having a smallest difference between its corresponding prediction luma block and the reconstructed luma block of the current coding unit, is selected and the selected refined motion vector is used for the chroma blocks to code the current coding unit.

Example 28. The apparatus according to example 21, wherein: the luma block is coded with a luma motion vector equal to a motion vector prediction, the luma motion vector corresponding to the selected luma block that is coded with an initial merge candidate from a merge candidate list; the refining comprises obtaining refined motion vectors by refining the motion vector predictions associated with merge candidates in the merge candidate list within corresponding refinement areas by adding refinements to the motion vector predictions to form the refined motion vectors and by comparing the reconstructed luma block and prediction luma blocks pointed to by the refined motion vectors; and one of the refined motion vectors, having a smallest difference between its corresponding prediction luma block and the reconstructed luma block of the current coding unit, is selected, and the selected refined motion vector is used for the chroma blocks to code the current coding unit.

Example 29. The apparatus according to any of examples 22, 23, and 25 to 28, wherein the inter-frame prediction process for frames of video is performed by an encoder, and wherein refinement areas are pre-determined at both the encoder and a decoder so that both the encoder and decoder use same refinement areas for the refining the one or more motion vectors.

Example 30. An apparatus, comprising means for: in an inter-frame prediction process for frames of video, selecting chroma blocks to be coded first for a current coding unit to form reconstructed chroma blocks of the current coding unit; refining one or more motion vectors that point from the reconstructed chroma blocks to prediction chroma blocks in a reference picture of the video; and selecting one of the refined one or more motion vectors to code a luma block for the current coding unit.

Example 31. The apparatus according to example 30, wherein: the chroma blocks are coded with a chroma motion vector equal to a motion vector prediction added to a motion vector difference the chroma motion vector corresponding to both chroma blocks; the refining comprises comparing the reconstructed chroma blocks with prediction chroma blocks pointed to by a few refined motion vectors created by adding refinements to the chroma motion vector, where the refined motion vectors are contained within a refinement area; and one of the refined motion vectors, having a smallest difference between its corresponding prediction chroma blocks and the reconstructed chroma blocks of the current coding unit, and the selected refined motion vector is used for coding the luma block of the current coding unit.

Example 32. The apparatus according to example 30, wherein: the chroma blocks are coded with a chroma motion vector equal to a motion vector prediction added to a motion vector difference, the chroma motion vector corresponding to both chroma blocks; the refining comprises comparing the reconstructed chroma blocks with prediction chroma blocks pointed to by a few refined motion vectors created by adding refinements to the chroma motion vector, where the refined motion vectors are contained within a refinement arca, as well as with the prediction chroma blocks pointed to by a few refined motion vectors created by adding refinements to motion vector predictions, associated with other merge candidates in a final merge candidate list, and contained within corresponding refinement areas; and one of the refined motion vectors, having a smallest difference between its corresponding prediction chroma blocks and the reconstructed chroma blocks of the current coding unit, is selected, and the selected refined motion vector is used for coding the luma block of the current coding unit.

Example 33. The apparatus according to example 30, wherein: the chroma blocks are coded with a chroma motion vector equal to a motion vector prediction, the chroma motion vector corresponding to both chroma blocks; the refining comprises comparing reconstructed chroma blocks with prediction chroma blocks associated with merge candidates in a merge candidate list; and a merge candidate, having a smallest difference between its corresponding prediction chroma blocks and the reconstructed chroma blocks of the current coding unit, is selected and the selected merge candidate is used for coding the luma block of the current coding unit.

Example 34. The apparatus according to example 30, wherein: the chroma blocks are coded with a chroma motion vector equal to a motion vector prediction, the chroma motion vector corresponding to both chroma blocks; the refining comprises comparing the reconstructed chroma blocks with prediction chroma blocks pointed to by a few refined motion vectors created by adding refinements to the motion vector prediction, where the refined motion vectors are contained within a refinement area; and one of the refined motion vectors, having a smallest difference between its corresponding prediction chroma blocks and the reconstructed chroma blocks of the current coding unit, is selected, and the selected refined motion vector is used for coding the luma blocks of the current coding unit.

Example 35. The apparatus according to example 30, wherein: the chroma blocks are coded with a chroma motion vector equal to a motion vector prediction, the chroma motion vector corresponding to both chroma blocks; the refining comprises comparing the reconstructed chroma blocks with prediction chroma blocks associated with merge candidates in a merge candidate list; and a merge candidate, having a smallest difference between its corresponding prediction chroma blocks and the reconstructed chroma blocks of the current coding unit, is selected.

Example 36. The apparatus according to example 35, wherein: the refining comprises comparing the reconstructed chroma blocks with prediction chroma blocks pointed to by refined motion vectors created by adding refinements to the motion vector prediction in the selected merge candidate, the refined motion vectors contained within a refinement area; and one of the refined motion vectors, having a smallest difference between its corresponding prediction chroma blocks and the reconstructed chroma blocks of the current coding unit, is selected, and the selected refined motion vector is used for the luma block of the current coding unit.

Example 37. The apparatus according to example 30, wherein: the chroma blocks are coded with a chroma motion vector equal to a motion vector prediction, the chroma motion vector corresponding to both chroma blocks; the refining comprises comparing the reconstructed chroma blocks with prediction chroma blocks associated with merge candidates in a merge candidate list; and a merge candidate, having a smallest difference between its corresponding prediction chroma blocks and the reconstructed chroma blocks of the current coding unit, is selected, and the selected merge candidate is used for coding the luma block of the current coding unit.

Example 38. The apparatus according to example 30, wherein: the refining comprises comparing the reconstructed chroma blocks with prediction chroma blocks pointed to by refined motion vectors created by adding refinements to motion vector predictions held in both an initial merge candidate and a selected merge candidate, wherein the refined motion vectors are contained within corresponding refinement areas; and one of the refined motion vectors, having a smallest difference between its corresponding prediction chroma blocks and the reconstructed chroma blocks of the current coding unit, is selected, and the selected refined motion vector is used for coding the luma block of the current coding unit.

Example 39. The apparatus according to example 30, wherein: the chroma blocks are coded with a chroma motion vector equal to a motion vector prediction, the chroma motion vector corresponding to both chroma blocks; the refining comprises comparing the reconstructed chroma blocks and prediction chroma blocks pointed to by refined motion vectors created by adding refinements to motion vector predictions associated with merge candidates in a merge candidate list, the refined motion vectors contained within corresponding refinement areas of the merge candidates; and one of the refined motion vectors, having a smallest difference between its corresponding prediction chroma blocks and the reconstructed chroma block of the current coding unit, is selected, and the selected refined motion vector is used for coding the luma block of the current coding unit.

Example 40. The apparatus according to any of examples 31, 32, 34, 35, 38, or 39, wherein the inter-frame prediction process for frames of video is performed by an encoder, and wherein refinement areas are pre-determined at both the encoder and a decoder so that both use same refinement areas for the refining the one or more motion vectors.

Example 41. An apparatus, comprising: one or more processors; and one or more memories storing instructions that, when executed by the one or more processors, cause the apparatus at least to perform: in an inter-frame prediction process for frames of video, selecting a luma block to be coded first for a current coding unit to form a reconstructed luma block of the current coding unit; refining one or more motion vectors that point from the luma block to a prediction luma block in a reference picture of the video; and selecting one of the refined one or more motion vectors to code chroma blocks for the current coding unit.

Example 42. The apparatus according to example 41, wherein: the luma block is coded with a luma motion vector equal to a motion vector prediction added to a motion vector difference, the luma motion vector corresponding to the selected luma block; the refining comprises creating refined motion vectors by adding refinements to the luma motion vector, where the refined motion vectors are contained within a refinement area; the refining comprises comparing the reconstructed luma block and prediction luma blocks pointed to by the refined motion vectors; a refined motion vector is selected that creates a smallest difference between the reconstructed luma block and a corresponding prediction luma block for the refined motion vector; and the selecting comprises using the selected refined motion vector to code the chroma blocks of the current coding unit.

Example 43. The apparatus according to example 41, wherein: the luma block is coded with a luma motion vector equal to a motion vector prediction added to a motion vector difference, the luma motion vector corresponding to the selected luma block, where the motion vector prediction is associated with a merge candidate from a merge candidate list; the refining comprises: comparing the reconstructed luma block with prediction luma blocks pointed to by a few refined motion vectors formed by adding refinements to the luma motion vector, where the refined motion vectors are contained within a refinement area associated with the merge candidate; and comparing the reconstructed luma block with prediction luma blocks pointed to by a few refined motion vectors formed by adding refinements to motion vector predictions associated with other merge candidates in the merge candidate list within corresponding refinement areas; and one of the refined motion vectors, having a smallest difference between its corresponding prediction luma block and the reconstructed luma block of the current coding unit, is selected and the selected refined motion vector is used to code the chroma blocks of the current coding unit.

Example 44. The apparatus according to example 41, wherein: the luma block is coded with a luma motion vector equal to a motion vector prediction, the luma motion vector corresponding to the selected luma block; the refining comprises comparing the reconstructed luma block with prediction luma blocks associated with merge candidates in a merge candidate list; and a merge candidate, having a smallest difference between its corresponding prediction luma block and the reconstructed luma block of the current coding nit, is selected and the selected merge candidate is used to code the chroma blocks of the current coding unit.

Example 45. The apparatus according to example 41, wherein: the luma block is coded with a luma motion vector equal to a motion vector prediction, the luma motion vector corresponding to the selected luma block; the refining comprises comparing the reconstructed luma block with prediction luma blocks pointed to by a few refined motion vectors created by adding refinements to the motion vector prediction, where the refined motion vectors are contained within a refinement area; and one of the refined motion vectors, having a smallest difference between its corresponding prediction luma block and the reconstructed luma block of the current coding unit, is selected, and the selected refined motion vector is used to code the chroma blocks of the current coding unit.

Example 46. The apparatus according to example 41, wherein: the luma block is coded with a luma motion vector equal to a motion vector prediction, the luma motion vector corresponding to the selected luma block; the refining comprises comparing the reconstructed luma block with prediction luma blocks associated with merge candidates in a merge candidate list; the one or more memories further store instructions that, when executed by the one or more processors, cause the apparatus at least to perform selecting a merge candidate with a smallest difference between its corresponding prediction luma block and the reconstructed luma block of the current coding unit; refining also comprises comparing the reconstructed luma block with prediction luma blocks pointed to by refined motion vectors formed by adding refinements to the motion vector prediction associated with the selected merge candidate, where the refined motion vectors are contained within a refinement area associated with the merge candidate; and one of the refined motion vectors, having a smallest difference between its corresponding prediction luma block and the reconstructed luma block of the current coding unit, is selected and the selected refined motion vector is used for the chroma blocks to code the current coding unit.

Example 47. The apparatus according to example 41, wherein: the luma block is coded with a luma motion vector equal to a motion vector prediction, the luma motion vector corresponding to the selected luma block that is coded with an initial merge candidate from a merge candidate list; the refining comprises comparing the reconstructed luma block with prediction luma blocks associated with merge candidates in the merge candidate list; the one or more memories further store instructions that, when executed by the one or more processors, cause the apparatus at least to perform selecting a merge candidate with a smallest difference between its corresponding prediction luma block and the reconstructed luma block of the current coding unit; motion vector predictions held in both the initial merge candidate and selected merge candidate are refined by adding refinements to the motion vector predictions to form refined motion vectors and by comparing the reconstructed luma block with prediction luma blocks pointed to by the refined motion vectors, where the refined motion vectors are contained within refinement areas associated with the initial merge candidate or selected merge candidate; and a refined motion vector, having a smallest difference between its corresponding prediction luma block and the reconstructed luma block of the current coding unit, is selected and the selected refined motion vector is used for the chroma blocks to code the current coding unit.

Example 48. The apparatus according to example 41, wherein: the luma block is coded with a luma motion vector equal to a motion vector prediction, the luma motion vector corresponding to the selected luma block that is coded with an initial merge candidate from a merge candidate list; the refining comprises obtaining refined motion vectors by refining the motion vector predictions associated with merge candidates in the merge candidate list within corresponding refinement areas by adding refinements to the motion vector predictions to form the refined motion vectors and by comparing the reconstructed luma block and prediction luma blocks pointed to by the refined motion vectors; and one of the refined motion vectors, having a smallest difference between its corresponding prediction luma block and the reconstructed luma block of the current coding unit, is selected, and the selected refined motion vector is used for the chroma blocks to code the current coding unit.

Example 49. The apparatus according to any of examples 42, 43, and 45 to 48, wherein the inter-frame prediction process for frames of video is performed by an encoder, and wherein refinement areas are pre-determined at both the encoder and a decoder so that both the encoder and decoder use same refinement areas for the refining the one or more motion vectors.

Example 50. An apparatus, comprising: one or more processors; and one or more memories storing instructions that, when executed by the one or more processors, cause the apparatus at least to perform: in an inter-frame prediction process for frames of video, selecting chroma blocks to be coded first for a current coding unit to form reconstructed chroma blocks of the current coding unit; refining one or more motion vectors that point from the reconstructed chroma blocks to prediction chroma blocks in a reference picture of the video; and selecting one of the refined one or more motion vectors to code a luma block for the current coding unit.

Example 51. The apparatus according to example 50, wherein: the chroma blocks are coded with a chroma motion vector equal to a motion vector prediction added to a motion vector difference the chroma motion vector corresponding to both chroma blocks; the refining comprises comparing the reconstructed chroma blocks with prediction chroma blocks pointed to by a few refined motion vectors created by adding refinements to the chroma motion vector, where the refined motion vectors are contained within a refinement area; and one of the refined motion vectors, having a smallest difference between its corresponding prediction chroma blocks and the reconstructed chroma blocks of the current coding unit, and the selected refined motion vector is used for coding the luma block of the current coding unit.

Example 52. The apparatus according to example 50, wherein: the chroma blocks are coded with a chroma motion vector equal to a motion vector prediction added to a motion vector difference, the chroma motion vector corresponding to both chroma blocks; the refining comprises comparing the reconstructed chroma blocks with prediction chroma blocks pointed to by a few refined motion vectors created by adding refinements to the chroma motion vector, where the refined motion vectors are contained within a refinement area, as well as with the prediction chroma blocks pointed to by a few refined motion vectors created by adding refinements to motion vector predictions, associated with other merge candidates in a final merge candidate list, and contained within corresponding refinement areas; and one of the refined motion vectors, having a smallest difference between its corresponding prediction chroma blocks and the reconstructed chroma blocks of the current coding unit, is selected, and the selected refined motion vector is used for coding the luma block of the current coding unit.

Example 53. The apparatus according to example 50, wherein: the chroma blocks are coded with a chroma motion vector equal to a motion vector prediction, the chroma motion vector corresponding to both chroma blocks; the refining comprises comparing reconstructed chroma blocks with prediction chroma blocks associated with merge candidates in a merge candidate list; and a merge candidate, having a smallest difference between its corresponding prediction chroma blocks and the reconstructed chroma blocks of the current coding unit, is selected and the selected merge candidate is used for coding the luma block of the current coding unit.

Example 54. The apparatus according to example 50, wherein: the chroma blocks are coded with a chroma motion vector equal to a motion vector prediction, the chroma motion vector corresponding to both chroma blocks; the refining comprises comparing the reconstructed chroma blocks with prediction chroma blocks pointed to by a few refined motion vectors created by adding refinements to the motion vector prediction, where the refined motion vectors are contained within a refinement area; and one of the refined motion vectors, having a smallest difference between its corresponding prediction chroma blocks and the reconstructed chroma blocks of the current coding unit, is selected, and the selected refined motion vector is used for coding the luma blocks of the current coding unit.

Example 55. The apparatus according to example 50, wherein: the chroma blocks are coded with a chroma motion vector equal to a motion vector prediction, the chroma motion vector corresponding to both chroma blocks; the refining comprises comparing the reconstructed chroma blocks with prediction chroma blocks associated with merge candidates in a merge candidate list; and a merge candidate, having a smallest difference between its corresponding prediction chroma blocks and the reconstructed chroma blocks of the current coding unit, is selected.

Example 56. The apparatus according to example 55, wherein: the refining comprises comparing the reconstructed chroma blocks with prediction chroma blocks pointed to by refined motion vectors created by adding refinements to the motion vector prediction in the selected merge candidate, the refined motion vectors contained within a refinement arca; and one of the refined motion vectors, having a smallest difference between its corresponding prediction chroma blocks and the reconstructed chroma blocks of the current coding unit, is selected, and the selected refined motion vector is used for the luma block of the current coding unit.

Example 57. The apparatus according to example 50, wherein: the chroma blocks are coded with a chroma motion vector equal to a motion vector prediction, the chroma motion vector corresponding to both chroma blocks; the refining comprises comparing the reconstructed chroma blocks with prediction chroma blocks associated with merge candidates in a merge candidate list; and a merge candidate, having a smallest difference between its corresponding prediction chroma blocks and the reconstructed chroma blocks of the current coding unit, is selected, and the selected merge candidate is used for coding the luma block of the current coding unit.

Example 58. The apparatus according to example 50, wherein: the refining comprises comparing the reconstructed chroma blocks with prediction chroma blocks pointed to by refined motion vectors created by adding refinements to motion vector predictions held in both an initial merge candidate and a selected merge candidate, wherein the refined motion vectors are contained within corresponding refinement areas; and one of the refined motion vectors, having a smallest difference between its corresponding prediction chroma blocks and the reconstructed chroma blocks of the current coding unit, is selected, and the selected refined motion vector is used for coding the luma block of the current coding unit.

Example 59. The apparatus according to example 50, wherein: the chroma blocks are coded with a chroma motion vector equal to a motion vector prediction, the chroma motion vector corresponding to both chroma blocks; the refining comprises comparing the reconstructed chroma blocks and prediction chroma blocks pointed to by refined motion vectors created by adding refinements to motion vector predictions associated with merge candidates in a merge candidate list, the refined motion vectors contained within corresponding refinement areas of the merge candidates; and one of the refined motion vectors, having a smallest difference between its corresponding prediction chroma blocks and the reconstructed chroma block of the current coding unit, is selected, and the selected refined motion vector is used for coding the luma block of the current coding unit.

Example 60. The apparatus according to any of examples 51, 52, 54, 55, 58, or 59, wherein the inter-frame prediction process for frames of video is performed by an encoder, and wherein refinement areas are pre-determined at both the encoder and a decoder so that both use same refinement areas for the refining the one or more motion vectors.

Example 61. A computer program, comprising instructions which, when the program is executed by an apparatus, cause the apparatus to carry out the methods of any of examples 1 to 20.

Example 62. The computer program according to example 61, wherein the computer program is a computer program product comprising a computer-readable medium bearing the instructions embodied therein for use with the apparatus.

Example 63. The computer program according to example 61, wherein the computer program is directly loadable into an internal memory of the apparatus.

As used in this application, the term “circuitry” may refer to one or more or all of the following:
(a) hardware-only circuit implementations (such as implementations in only analog and/or digital circuitry) and
(b) combinations of hardware circuits and software, such as (as applicable): (i) a combination of analog and/or digital hardware circuit(s) with software/firmware and (ii) any portions of hardware processor(s) (including digital signal processor(s)) with software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

Embodiments herein may be implemented in software (executed by one or more processors), hardware (e.g., an application specific integrated circuit), or a combination of software and hardware. In an example embodiment, the software (e.g., application logic, an instruction set) is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted, e.g., in FIG. 10. A computer-readable medium may comprise a computer-readable storage medium (e.g., memories 1225 or other device) that may be any media or means that can contain, store, and/or transport the instructions for use by or in connection with an instruction execution system, apparatus, or device, such as a computer. A computer-readable storage medium does not comprise propagating signals, and therefore may be considered to be non-transitory. The term “non-transitory”, as used herein, is a limitation of the medium itself (i.e., tangible, not a signal) as opposed to a limitation on data storage persistency (e.g., RAM, random access memory, versus ROM, read-only memory).

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

The following abbreviations that may be found in the specification and/or the drawing figures are defined as follows:
2D two dimensional
AMVP advanced motion vector prediction
BiMVD Bidirectional MVD (motion vector difference)
CTU coding tree unit
CU coding unit
ECM Enhanced Compression Model
JVET Joint video experts team
MMVD merge mode with motion vector difference
MV motion vector
MVD motion vector difference
MVP motion vector prediction
SAD sum of absolute difference
SMVD Symmetric Motion Vector Difference
VVC Versatile Video Coding

1-63. (canceled)

64. A method, comprising:
in an inter-frame prediction process for frames of video, selecting a luma block to be encoded or decoded for a current coding unit to form a reconstructed luma block of the current coding unit;
refining one or more motion vectors that point from the luma block to a prediction luma block in a reference picture of the video; and
selecting one of the refined one or more motion vectors to encode or decode chroma blocks for the current coding unit.

65. The method according to claim 64, wherein:
the luma block is coded with a luma motion vector equal to a motion vector prediction added to a motion vector difference, the luma motion vector corresponding to the selected luma block;
the refining comprises creating refined motion vectors by adding refinements to the luma motion vector, where the refined motion vectors are contained within a refinement area;
the refining comprises comparing the reconstructed luma block and prediction luma blocks pointed to by the refined motion vectors;
a refined motion vector is selected that creates a smallest difference between the reconstructed luma block and a corresponding prediction luma block for the refined motion vector; and
the selecting comprises using the selected refined motion vector to encode or decode the chroma blocks of the current coding unit.

66. The method according to claim 64, wherein:
the luma block is encoded or decoded with a luma motion vector equal to a motion vector prediction added to a motion vector difference, the luma motion vector corresponding to the selected luma block, where the motion vector prediction is associated with a merge candidate from a merge candidate list;
the refining comprises:
comparing the reconstructed luma block with prediction luma blocks pointed to by a few refined motion vectors formed by adding refinements to the luma motion vector, where the refined motion vectors are contained within a refinement area associated with the merge candidate; and
comparing the reconstructed luma block with prediction luma blocks pointed to by a few refined motion vectors formed by adding refinements to motion vector predictions associated with other merge candidates in the merge candidate list within corresponding refinement areas; and
one of the refined motion vectors, having a smallest difference between its corresponding prediction luma block and the reconstructed luma block of the current coding unit, is selected and the selected refined motion vector is used to encode or decode the chroma blocks of the current coding unit.

67. The method according to claim 64, wherein:
the luma block is encoded or decoded with a luma motion vector equal to a motion vector prediction, the luma motion vector corresponding to the selected luma block;
the refining comprises comparing the reconstructed luma block with prediction luma blocks associated with merge candidates in a merge candidate list; and
a merge candidate, having a smallest difference between its corresponding prediction luma block and the reconstructed luma block of the current coding unit, is selected and the selected merge candidate is used to encode or decode the chroma blocks of the current coding unit.

68. The method according to claim 64, wherein:
the luma block is encoded or decoded with a luma motion vector equal to a motion vector prediction, the luma motion vector corresponding to the selected luma block;
the refining comprises comparing the reconstructed luma block with prediction luma blocks pointed to by a few refined motion vectors created by adding refinements to the motion vector prediction, where the refined motion vectors are contained within a refinement area; and
one of the refined motion vectors, having a smallest difference between its corresponding prediction luma block and the reconstructed luma block of the current coding unit, is selected, and the selected refined motion vector is used to encode or decode the chroma blocks of the current coding unit.

69. The method according to claim 64, wherein:
the luma block is encoded or decoded with a luma motion vector equal to a motion vector prediction, the luma motion vector corresponding to the selected luma block;
the refining comprises comparing the reconstructed luma block with prediction luma blocks associated with merge candidates in a merge candidate list;
the method further comprises selecting a merge candidate with a smallest difference between its corresponding prediction luma block and the reconstructed luma block of the current coding unit;
refining also comprises comparing the reconstructed luma block with prediction luma blocks pointed to by refined motion vectors formed by adding refinements to the motion vector prediction associated with the selected merge candidate, where the refined motion vectors are contained within a refinement area associated with the merge candidate; and
one of the refined motion vectors, having a smallest difference between its corresponding prediction luma block and the reconstructed luma block of the current coding unit, is selected and the selected refined motion vector is used for the chroma blocks to encode or decode the current coding unit.

70. The method according to claim 64, wherein:
the luma block is encoded or decoded with a luma motion vector equal to a motion vector prediction, the luma motion vector corresponding to the selected luma block that is encoded or decoded with an initial merge candidate from a merge candidate list;
the refining comprises comparing the reconstructed luma block with prediction luma blocks associated with merge candidates in the merge candidate list;
the method further comprises selecting a merge candidate with a smallest difference between its corresponding prediction luma block and the reconstructed luma block of the current coding unit;
motion vector predictions held in both the initial merge candidate and selected merge candidate are refined by adding refinements to the motion vector predictions to form refined motion vectors and by comparing the reconstructed luma block with prediction luma blocks pointed to by the refined motion vectors, where the refined motion vectors are contained within refinement areas associated with the initial merge candidate or selected merge candidate; and
a refined motion vector, having a smallest difference between its corresponding prediction luma block and the reconstructed luma block of the current coding unit, is selected and the selected refined motion vector is used for the chroma blocks to encode or decode the current coding unit.

71. The method according to claim 64, wherein:
the luma block is encoded or decoded with a luma motion vector equal to a motion vector prediction, the luma motion vector corresponding to the selected luma block that is encoded or decoded with an initial merge candidate from a merge candidate list;
the refining comprises obtaining refined motion vectors by refining the motion vector predictions associated with merge candidates in the merge candidate list within corresponding refinement areas by adding refinements to the motion vector predictions to form the refined motion vectors and by comparing the reconstructed luma block and prediction luma blocks pointed to by the refined motion vectors; and
one of the refined motion vectors, having a smallest difference between its corresponding prediction luma block and the reconstructed luma block of the current coding unit, is selected, and the selected refined motion vector is used for the chroma blocks to encode or decode the current coding unit.

72. The method according to claim 64 wherein the inter-frame prediction process is performed by an encoder or a decoder.

73. An apparatus, comprising:
one or more processors; and
one or more memories storing instructions that, when executed by the one or more processors, cause the apparatus at least to perform:
in an inter-frame prediction process for frames of video, selecting a luma block to be encoded or decoded first for a current coding unit to form a reconstructed luma block of the current coding unit;
refining one or more motion vectors that point from the luma block to a prediction luma block in a reference picture of the video; and
selecting one of the refined one or more motion vectors to encode or decode chroma blocks for the current coding unit.

74. The apparatus according to claim 73, wherein:
the luma block is encoded or decoded with a luma motion vector equal to a motion vector prediction added to a motion vector difference, the luma motion vector corresponding to the selected luma block;
the refining comprises creating refined motion vectors by adding refinements to the luma motion vector, where the refined motion vectors are contained within a refinement area;
the refining comprises comparing the reconstructed luma block and prediction luma blocks pointed to by the refined motion vectors;
a refined motion vector is selected that creates a smallest difference between the reconstructed luma block and a corresponding prediction luma block for the refined motion vector; and
the selecting comprises using the selected refined motion vector to encode or decode the chroma blocks of the current coding unit.

75. The apparatus according to claim 73, wherein:
the luma block is encoded or decoded with a luma motion vector equal to a motion vector prediction added to a motion vector difference, the luma motion vector corresponding to the selected luma block, where the motion vector prediction is associated with a merge candidate from a merge candidate list;
the refining comprises:
comparing the reconstructed luma block with prediction luma blocks pointed to by a few refined motion vectors formed by adding refinements to the luma motion vector, where the refined motion vectors are contained within a refinement area associated with the merge candidate; and
comparing the reconstructed luma block with prediction luma blocks pointed to by a few refined motion vectors formed by adding refinements to motion vector predictions associated with other merge candidates in the merge candidate list within corresponding refinement areas; and
one of the refined motion vectors, having a smallest difference between its corresponding prediction luma block and the reconstructed luma block of the current coding unit, is selected and the selected refined motion vector is used to encode or decode the chroma blocks of the current coding unit.

76. The apparatus according to claim 73, wherein:
the luma block is encoded or decoded with a luma motion vector equal to a motion vector prediction, the luma motion vector corresponding to the selected luma block;
the refining comprises comparing the reconstructed luma block with prediction luma blocks associated with merge candidates in a merge candidate list; and
a merge candidate, having a smallest difference between its corresponding prediction luma block and the reconstructed luma block of the current coding unit, is selected and the selected merge candidate is used to encode or decode the chroma blocks of the current coding unit.

77. The apparatus according to claim 73, wherein:
the luma block is encoded or decoded with a luma motion vector equal to a motion vector prediction, the luma motion vector corresponding to the selected luma block;
the refining comprises comparing the reconstructed luma block with prediction luma blocks pointed to by a few refined motion vectors created by adding refinements to the motion vector prediction, where the refined motion vectors are contained within a refinement area; and
one of the refined motion vectors, having a smallest difference between its corresponding prediction luma block and the reconstructed luma block of the current coding unit, is selected, and the selected refined motion vector is used to encode or decode the chroma blocks of the current coding unit.

78. The apparatus according to claim 73 wherein:
the luma block is encoded or decoded with a luma motion vector equal to a motion vector prediction, the luma motion vector corresponding to the selected luma block;
the refining comprises comparing the reconstructed luma block with prediction luma blocks associated with merge candidates in a merge candidate list;
the one or more memories further store instructions that, when executed by the one or more processors, cause the apparatus at least to perform selecting a merge candidate with a smallest difference between its corresponding prediction luma block and the reconstructed luma block of the current coding unit;
refining also comprises comparing the reconstructed luma block with prediction luma blocks pointed to by refined motion vectors formed by adding refinements to the motion vector prediction associated with the selected merge candidate, where the refined motion vectors are contained within a refinement area associated with the merge candidate; and
one of the refined motion vectors, having a smallest difference between its corresponding prediction luma block and the reconstructed luma block of the current coding unit, is selected and the selected refined motion vector is used for the chroma blocks to encode or decode the current coding unit.

79. The apparatus according to claim 73, wherein:
the luma block is encoded or decoded with a luma motion vector equal to a motion vector prediction, the luma motion vector corresponding to the selected luma block that is encoded or decoded with an initial merge candidate from a merge candidate list;
the refining comprises comparing the reconstructed luma block with prediction luma blocks associated with merge candidates in the merge candidate list;
the one or more memories further store instructions that, when executed by the one or more processors, cause the apparatus at least to perform selecting a merge candidate with a smallest difference between its corresponding prediction luma block and the reconstructed luma block of the current coding unit;
motion vector predictions held in both the initial merge candidate and selected merge candidate are refined by adding refinements to the motion vector predictions to form refined motion vectors and by comparing the reconstructed luma block with prediction luma blocks pointed to by the refined motion vectors, where the refined motion vectors are contained within refinement areas associated with the initial merge candidate or selected merge candidate; and
a refined motion vector, having a smallest difference between its corresponding prediction luma block and the reconstructed luma block of the current coding unit, is selected and the selected refined motion vector is used for the chroma blocks to encode or decode the current coding unit.

80. The apparatus according to claim 73, wherein:
the luma block is encoded or decoded with a luma motion vector equal to a motion vector prediction, the luma motion vector corresponding to the selected luma block that is encoded or decoded with an initial merge candidate from a merge candidate list;
the refining comprises obtaining refined motion vectors by refining the motion vector predictions associated with merge candidates in the merge candidate list within corresponding refinement areas by adding refinements to the motion vector predictions to form the refined motion vectors and by comparing the reconstructed luma block and prediction luma blocks pointed to by the refined motion vectors; and
one of the refined motion vectors, having a smallest difference between its corresponding prediction luma block and the reconstructed luma block of the current coding unit, is selected, and the selected refined motion vector is used for the chroma blocks to encode or decode the current coding unit.

81. The apparatus according to claim 73, wherein the inter-frame prediction process for frames of video is performed by an encoder or a decoder.

82. A non-transitory computer readable medium comprising instructions stored thereon for performing at least the following:
in an inter-frame prediction process for frames of video, selecting a luma block to be encoded or decoded for a current coding unit to form a reconstructed luma block of the current coding unit;
refining one or more motion vectors that point from the luma block to a prediction luma block in a reference picture of the video; and
selecting one of the refined one or more motion vectors to encode or decode chroma blocks for the current coding unit.

83. The apparatus according to claim 82, wherein the inter-frame prediction process for frames of video is performed by an encoder or a decoder.
